(19) United States
(12) Patent Application Publication
(10) Pub. No.: US 2026/0132298 A1
(43) Pub. Date: May 14, 2026

(54) A METHOD FOR PRODUCING INTERFERENCE ELEMENTS

(71) Applicant: BASF SE, Ludwigshafen am Rhein (DE)

(72) Inventors: Nikolay A. GRIGORENKO, Basel (CH); Gloria RUIZ GOMEZ, Basel (CH); Andre OSWALD, Schweizerhalle (Muttenz) (CH); Oliver SEEGER, Ludwigshafen am Rhein (DE)

(21) Appl. No.: 18/704,115

(22) PCT Filed: Oct. 20, 2022
(86) PCT No.: PCT/EP2022/079306

§ 371 Date: Apr. 24, 2024

(30) Foreign Application Priority Data
Oct. 26, 2021 (EP) 21204791.4

(51) Int. Cl. C09D 5/36; C09D 7/40; C09D 7/45; C09D 7/61; C09D 7/65

(52) U.S. Cl. CPC C09D 5/36; C09D 7/45; C09D 7/61; C09D 7/65; C09D 7/67; C09D 7/68

(57) ABSTRACT

The present invention relates to a decorative, or security element and a method for producing the decorative, or security element. The decorative, or security element comprises in this order (a) a substrate; (b) a coating, comprising transition metal particles (A) having a number mean diameter of from 15 nm to 700 nm, wherein the transition metal is selected from silver, copper, gold and palladium, especially silver and copper, very especially silver; (c) optionally a protective coating; wherein the coating (b) is derived from (b1) a solvent based composition, comprising the transition metal particles and a vehicle; and (b2) the coating (b) has a three layer structure: (b2a) a layer, comprising the transition metal particles and a vehicle; (b2b) a layer, comprising the vehicle, which is essentially free of transition metal particles; (b2c) a layer, comprising the transition metal particles and the vehicle. The method comprises the steps of i) applying a solvent based composition comprising transition metal particles and the vehicle; on at least part of the surface of the substrate, and ii) drying the solvent based composition; iii) curing the solvent based composition so as to form the three-layer structure which exhibits intensive angle-dependent colors in reflection on the coating side and/or on the substrate side of the decorative, or security element and a distinctive color in transmission; and iii) optionally applying a protective coating on the coating (b). The three-layer structure exhibits intensive angle-dependent colors in reflection on the coating side and, optionally, on the substrate side, due to thin-film interference in a Fabry-Perot resonator structure, which is produced in one coating or printing step.

The present invention relates to a decorative, or security element and a method for producing the decorative, or security element. The decorative, or security element comprises in this order (a) a substrate; (b) a coating, comprising transition metal particles (A) having a number mean diameter of from 15 nm to 700 nm, wherein the transition metal is selected from silver, copper, gold and palladium, especially silver and copper, very especially silver; (c) optionally a protective coating; wherein the coating (b) is derived from (b1) a solvent based composition, comprising the transition metal particles and a vehicle;

and (b2) the coating (b) has a three layer structure: (b2a) a layer, comprising the transition metal particles and a vehicle; (b2b) a layer, comprising the vehicle, which is essentially free of transition metal particles; (b2c) a layer, comprising the transition metal particles and the vehicle. The method comprises the steps of i) applying a solvent based composition comprising transition metal particles and the vehicle; on at least part of the surface of the substrate, and ii) drying the solvent based composition; iii) curing the solvent based composition so as to form the three-layer structure which exhibits intensive angle-dependent colors in reflection on the coating side and/or on the substrate side of the decorative, or security element and a distinctive color in transmission; and iii) optionally applying a protective coating on the coating (b). The three-layer structure exhibits intensive angle-dependent colors in reflection on the coating side and, optionally, on the substrate side, due to thin-film interference in a Fabry-Perot resonator structure, which is produced in one coating or printing step.

### PRIOR ART

WO2015/120975A1 (DE102014001842A1) relates to a method for manufacturing a security element (1) having negative writing for a security paper or an object of value, in particular a value document, having the following steps:
a) supplying a transparent carrier substrate (2);
b)providing the carrier substrate (2) with an embossed emboss-lacquer layer (6);
c) printing the emboss-lacquer layer (6) with a flowable, metal pigments-containing ink layer (8) in the form of a predetermined pattern having ink-layer regions (4) and recesses (5) forming the negative writing between the ink-layer regions (4), so that at the underside of each individual ink-layer region (4) at which the ink layer (8) and the emboss-lacquer layer (6) face each other, metal pigments align themselves spatially along the emboss structure (7) of the emboss-lacquer layer (6) and form a first lower ink-layer metallization (9);
d) bringing in contact the ink layer (8) with an embossing tool, preferably at elevated pressure and at elevated temperature, so that the upper side of each individual ink-layer region is provided with an emboss structure along which metal pigments align themselves spatially and form the second, upper ink-layer metallization (10).

WO2016/170160A1 relates to a process for the preparation of thin silver nano-particle layers, which are produced directly on a substrate as part of a coating or printing process. The layers show different colors in transmittance and reflectance. The layers do not show the typical conductivity of metallic layers, since the particles are essentially discrete particles which are not sintered.

DE4419173A1 relates to magnetisable pearlescent pigments based on multi-coated, non-ferromagnetic metal flakes having (a) a first ferromagnetic layer containing Fe, Co, Ni, magnetite and/or gamma-Fe₂O₃; (b) a second layer of Si and/or A1 oxide(s) and/or hydrated oxide(s); (c) a third layer of metal and/or metal oxide with non-selective absorption; and (d) opt. a fourth layer of metal oxide, which is colorless or has selective absorption; and a process of producing the pigments.

Multi-layer interference devices, comprising metallic Fabry-Perot resonator structures, are widely known and can be used in manufacturing of security elements as described, for example in WO2016173695A1, WO2016173696A1, WO2017080641A1, WO2017092865A1, WO2016091381A1, WO2017008897A1 and WO2017054922A1. Manufacturing of such interference devices is based on multi-step wet chemical and/or physical coating processes. Likewise, U.S. Pat. No. 7,630,109B2 discloses a multilayer thin film filter, wherein an organic dielectric layer is serving as a spacer layer in a Fabry-Perot structure. The dielectric layer has embossed regions of varying thicknesses wherein the thickness within a region is substantially uniform. Each different region of a different thickness produces a different color (shift). The size of one of the embossed adjacent regions is such that the color of said one region is uniform and cannot be seen by a human eye as different in color from the uniform color of an adjacent region thereto, and wherein the color within a region can be seen with magnification of at least 10:1. This serves as a covert color coding system useful as a security device. The methods for manufacturing such Fabry-Perot color filters are based on multi-step processes, utilizing metal evaporation or sputtering techniques.

PCT/EP2022/052247 relates to radically curable compositions, comprising (A) silver nanoplatelets, (B) one reactive diluent comprising1 to 4 (meth)acrylate groups; (C) one, or more urethane (meth)acrylates (C), which are obtainable by reaction of the following components:
(a) at least one isocyanate having two isocyanate groups,
(b) at least one polyalkylene oxide polyether having at least 2 hydroxyl groups,
(c) at least one hydroxy-functional (meth)acrylate having one hydroxyl group and one (meth)acrylate group,
(d) at least one compound having at least one isocyanate reactive group and at least one acid function,
(e) at least one basic compound which is present for neutralization or partial neutralization of the acid groups of component (d),
(f) optionally at least one monoalcohol having one hydroxy function;
(D) one, or more photonitiators; printing inks containing the compositions and their use for the production security products. Coatings obtained after curing of the compositions, show one color, when observed in transmission and another color, when observed in reflection on both sides of the cured coating. The compositions described in PCT/EP2022/052247 are preferably solvent-free.

PCT/EP2022/062753 relates to compositions, comprising
(A) platelet-shaped transition metal particles, wherein the number mean diameter of the platelet-shaped transition metal particles, present in the composition, is in the range of from 15 nm to 1000 nm, the transition metal is selected from silver, copper, gold and palladium, especially silver and copper, very especially silver;
(B) one, or more reactive diluents (B);
(C) optionally one, or more oligomers (C);
(D) one, or more photonitiators (D);
(E) at least a surfactant (E), which is a block copolymer, comprising at least a block A and a block B, wherein
a) the block A comprises
a1) monomer units (A1) derived from a compound selected from alkyl (meth)acrylates, alkyl (meth)acrylamides, or any mixture thereof, and
a2) monomer units (A2) derived from a hydroxy group, or ether group containing alkyl (meth)acrylate;
b) the block B comprises monomer units (B) derived from a compound selected from fluorinated (meth)acrylic esters of formula

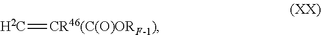

wherein
R⁴⁶ is H, or a methyl group; and
R_{F-1} is an organic residue containing a perfluorinated alkyl group;
(F) optionally one, or more polymeric binders;
(G) optionally one, or more solvents; and
(H) optionally further additives. The compositions of EP21173520.4 are preferably solvent-free.

WO2022/101207 relates to compositions, comprising silver nanoplatelets, wherein the silver nanoplatelets are capped by a dithiocarbamate anion of formula

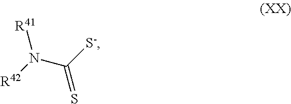

wherein
R⁴¹ is a C₂-C₄alkyl group, which is substituted by one, or two hydroxy groups, and
R⁴² is a C₁-C₄alkyl group, or a C₂-C₄alkyl group, which is substituted by one, or two hydroxy groups; and the use thereof in UV-Vis radiation curable screen printing hybrid security inks (cf. WO2022/101224 and WO2022/101225).

WO2020/152021 relates to security, or decorative elements, comprising a transparent, or translucent substrate, which may contain indicia or other visible features in or on its surface, and on at least part of the substrate surface, a first layer, comprising transition metal particles having an average diameter of from 5 nm to 500 nm and a binder, on at least part of the first layer a second layer, comprising an organic material and having a refractive index of from 1.2 to 2.3 and having a thickness of from 20 to 1000 nm, wherein the transition metal is silver, copper, gold and palladium, wherein the weight ratio of transition metal particles to binder in the first layer is in the range from 20:1 to 1:2 in case the binder is a polymeric binder, or wherein the weight ratio of transition metal particles to binder in the first layer is in the range from 5:1 to 1:15 in case the binder is an UV curable binder.

It is the purpose of the present invention to provide decorative, or security elements, comprising a three-layer structure which exhibits intensive angle-dependent colors (color flops) in reflection on the coating side and/or on the substrate side of the decorative, or security element and a distinctive color in transmission, and methods for manufacturing such elements.

Accordingly, the present invention is directed to a decorative, or security element, comprising in this order
(a) a substrate;
(b) a coating, comprising transition metal particles (A) having a number mean diameter in the range of from 15 nm to 700 nm, wherein the transition metal is selected from silver, copper, gold and palladium, especially silver and copper, very especially silver;
(c) optionally a protective coating; wherein the coating (b) is derived from
(b1) a solvent based composition, comprising the transition metal particles and a vehicle; and
(b2) the coating (b) has a three-layer structure:
(b2a) a layer, comprising the transition metal particles and the vehicle;
(b2b) a layer, comprising the vehicle, which is essentially free of transition metal particles; and
(b2c) a layer, comprising the transition metal particles and the vehicle; wherein the three-layer structure exhibits intensive angle-dependent colors in reflection on the coating side and/or on the substrate side of the decorative, or security element and a distinctive color in transmission; and to a method for producing the decorative, or security element, comprising the steps of
i) applying a solvent based composition comprising transition metal particles and the vehicle; on at least part of the surface of the substrate, and
ii) drying the solvent based composition;
iii) curing the solvent based composition so as to form the three-layer structure which exhibits intensive angle-dependent colors in reflection on the coating side and/or on the substrate side of the decorative, or security element and a distinctive color in transmission; and
iii) optionally applying a protective coating on the coating (b).

Silver nanoplatelets, which show a turquoise, or blue color in transmission and a yellowish metallic color in reflection, will result in different color flop combinations, as compared to silver nanoplatelets, which show a magenta color in transmission and a greenish metallic color in reflection, due to different absorption spectra.

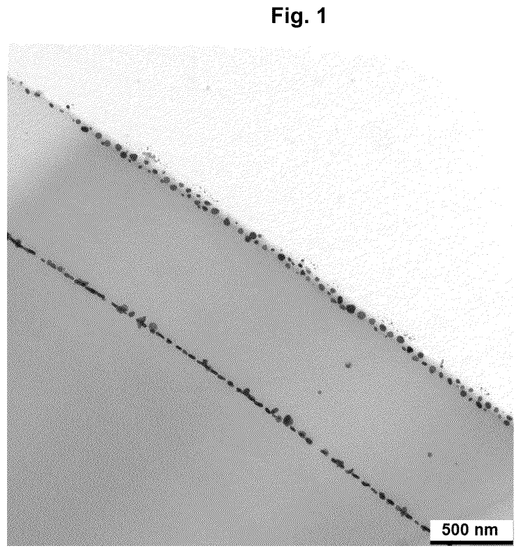

FIG. 1: TEM (transmission electron microscopy) image of cross-section of coating obtained Application Example 4. 5

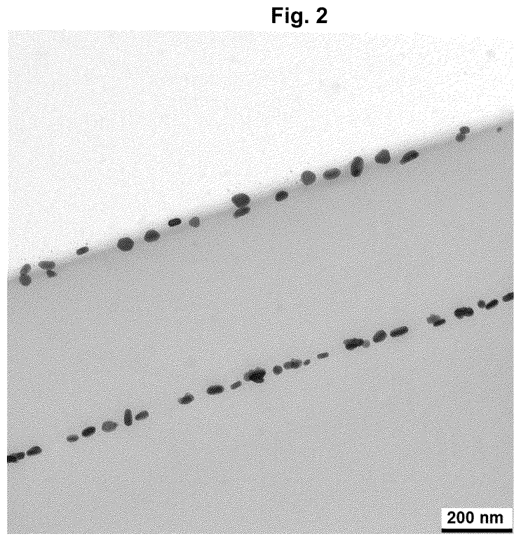

FIG. 2: TEM image of cross-section of coating obtained in Application Example 5.

In a preferred embodiment the three-layer structure exhibits intensive angle-dependent colors in reflection on the coating side and, optionally, on the substrate side, due to thin-film interference in a Fabry-Perot resonator structure. In addition, the three-layer structure shows preferably a distinct color, for example, brown-orange, magenta, violet, or blue, in transmission. In a particularly preferred embodiment the three-layer structure exhibits intensive angle-dependent colors in reflection on the coating side, colored metallic reflection on the substrate side and a distinct color in transmission.

The effect is caused by the self-assembly of transition metal particles on opposite surfaces of the coating produced from the solvent based composition, i.e. the unique feature of the solvent based composition is that three-layer structure (b2) is created in one coating or printing step, which comprises on the substrate in this order the layers (b2a), (b2b) and
(b2c).

The coating (b) has a three-layer structure (b2), i. e. Fabry-Perot resonator structure:
(b2a) a layer, comprising the transition metal particles and the vehicle;
(b2b) a layer, comprising the vehicle; and
(b2c) a layer, comprising the transition metal particles and the vehicle (=interference stack).

The interference stack has preferably a thickness in the range of from 200 to 600 nm, more preferably in the range of from 250 to 450 nm. The interference colors are resistant to overcoating. Applying the solvent based composition is preferably done by a slot die coating process, or a gravure, a flexographic, or an ink jet printing process. At present, the slot die coating process and the ink jet printing process are most preferred.

The Fabry-Perot resonator structure is produced in one coating or printing step, thus reducing manufacturing costs compared to existing technologies.

Advantageously, the three-layer structure may be overcoated, or laminated with readily available materials, having refractive index in the range of 1.4 to 1.6, without the loss of angle-dependent color change.

Advantageously, the interference color may be tuned by adding low refractive index (LRI) layers and/or high refractive index (HRI) layers, such as for example ZnS, or TiO₂ layers, below, or above the three-layer structure.

The term “high refractive index (HRI)” is meant to mean a refractive index of more than 1.65. HRI layer is taken to mean layers whose refractive index is more than 1.65, such as, for example, layers of titanium dioxide, zinc sulfide, or mixtures thereof.

The term “low refractive index (LRI)” is meant to mean a refractive index of less than 1.50. LRI layer is taken to mean layers whose refractive index is less than 1.50, such as, for example, layers of silicon dioxide, aluminium oxide, or mixtures thereof.

Advantageously, the three-layer structure may be printed on metallized, or partially de-metallized substrates. The metal will significantly change the interference color flop due to plasmonic meta-surface effect.

Advantageously, the thickness of the three-layer structure may be controlled by embossing an UV curable solvent based composition before UV curing after solvent evaporation, or by bringing it in contact with a mirror-shim.

Advantageously, the solvent-based compositions are applied by slot-dye coating, which enables the production of the three-layer structure in a thickness in the range of from 200 to 600 nm and provides a very high degree of thickness homogeneity.

Advantageously, the solvent-based compositions may be cationically polymerizable solvent-based compositions because of lack of oxygen inhibition upon UV curing at the low thickness of the three-layer structure.

The wording, that layer (b2b) is essentially free of transition metal particles, means that the number of transition metal particles in layer (b2b) is less than, or equal to 15%, preferably less than, or equal to 10%, more preferably less than, or equal to 5% and most preferred less than, or equal to 2% based on the total number of transition metal particles contained in layers (b2a), (b2b) and (b2c). The majority of the transition metal particles is contained in layers (b2a) and (b2c). In a particularly preferred embodiment layer (b2b) contains almost no transition metal particles.

The term “distinctive color in transmission” means that the three layer structure has a hue in transmission, or is not grey in transmission.

In the context of the composition of the present invention the term “solvent” means a compound with boiling point of below 250° C., preferably, below 200° C., which substantially evaporates during and/or after coating or printing of the compositions according to the present invention prior to the radiation curing step.

The term “security document” refers to a document which is usually protected against counterfeit or fraud by at least one security feature. Examples of security documents include without limitation value documents and value commercial goods.

The term “UV-Vis curable” and “UV-Vis curing” refers to radiation-curing by photo-polymerization, under the influence of an irradiation having wavelength components in the UV or in the UV and visible part of the electromagnetic spectrum (typically 100 nm to 800 nm, preferably between 150 and 600 nm and more preferably between 200 and 400 nm).

In a preferred embodiment the solvent based composition comprises
(B) one, or more reactive diluents (B);
(C) optionally one, or more oligomers (C);
(D) one, or more photoinitiators (D);
(E) optionally one, or more surfactants (E),
(F) optionally one, or more polymeric binders;
(G) one, or more solvents; and
(H) optionally further additives.

The vehicle comprises preferably a leveling agent and/or a thickener as further additive (H).

A) Transition Metal Particles, especially Silver Nanoplatelets

The transition metal particles are preferably transition metal nanoplatelets. The term “transition metal nanoplatelets” is a term used in the art and as such is understood by the skilled person. In the context of the present invention, transition metal nanoplatelets are preferably any transition metal nanoplatelets having a number mean diameter of from 15 nm to 700, especially a number mean diameter of from 20 to 600 nm, very especially a number mean diameter of from 20 nm to 300 nm. The transition metal nanoplatelets have preferably a number mean thickness of from 2 nm to 40 nm, especially a number mean thickness of from 2 nm to 40 nm, very especially a number mean thickness of from 4 to 30 nm. Particularly preferred are transition metal nanoplatelets having a number mean diameter of from 15 nm to 700 and a number mean thickness of from 2 nm to 40 nm, especially a number mean diameter of from 20 to 600 nm and a number mean thickness of from 2 nm to 40 nm and very especially a number mean diameter of from 20 nm to 300 nm and a number mean thickness of from 4 to 30 nm.

The wording that the “number mean diameter, or number mean thickness is in the range of from X to Y nm (or is from X to Y nm)” means: X nm≤number mean diameter, or number mean thickness≤Y nm.

As used herein, the term “number mean diameter of the silver nanoplatelets” refers to the mean diameter of at least 500 randomly selected silver nanoplatelets determined by transmission electron microscopy (TEM) from TEM images using Image analysis software: ParticleSizer (Thorsten Wagner (2016) ij-particlesizer: ParticleSizer 1.0.9. Zenodo; 10.5281/zenodo.820296) and ImageJ version 1.53f51, wherein the diameter of a silver nanoplatelet is the maximum dimension of said silver nanoplatelet (maximal Feret diameter) (oriented parallel to the plane of a TEM image (recorded at magnification 20.000×)).

As used herein, the term “number mean thickness of silver nanoplatelets” refers to the mean thickness of at least 300 randomly selected silver nanoplatelets determined by TEM from cross-sectional TEM images of the silver nanoplatelets (recorded at magnification 25.000×) by fitting ellipses to the cross-sectioned particles by the Image analysis software (ParticleSizer) and taking the minor axis (the shortest diameter) of the fitted ellipse as particle thickness.

TEM analysis was performed using an EM 910 instrument from ZEISS, INST.109, in bright field mode at an e-beam acceleration voltage of 100 kV.

The diameter is the longer side of the nanoplatelet (width). The thickness is the shorter side of the nanoplatelet (height).

The aspect ratio of the nanoplatelets is the ratio of its longest dimension, such as, for example, its diameter to its shortest dimension, such as, for example, its thickness. For example, the aspect ratio of a disk is the ratio of its diameter to its thickness. The mean aspect ratio (defined as the ratio of mean diameter to mean thickness) being larger than 1.5, preferably larger than 1.6 and more preferably larger than 1.7.

The transition metal is selected from silver, copper, gold and palladium. More preferred are silver and copper. Most preferred is silver.

In general, the silver nanoplatelets have a number mean diameter in the range of from 15 to 700 nm, especially 20 nm to 600, very especially 20 to 300 nm. The number mean thickness is preferably in the range of from 2 nm to 40 nm, very especially 4 to 30 nm.

The term “silver nanoplatelets” is a term used in the art and as such is understood by the skilled person. In the context of the present invention, silver nanoplatelets are preferably silver nanoplatelets having a number mean diameter of in the range from 15 nm to 700 and a number mean thickness in the range of from 2 nm to 40 nm, especially a number mean diameter in the range of from 20 to 600 nm and a number mean thickness in the range of from 2 nm to 40 nm and very especially a number mean diameter in the range of from 20 nm to 300 nm and a number mean thickness in the range of from 4 to 30 nm.

The aspect ratio of the silver nanoplatelets is the ratio of its longest dimension, such as, for example, its diameter to its shortest dimension, such as, for example, its thickness. For example, the aspect ratio of a disk is the ratio of its diameter to its thickness. The mean aspect ratio (defined as the ratio of mean diameter to mean thickness) being larger than 1.5, preferably larger than 1.6 and more preferably larger than 1.7.

The silver nanoplatelets may be in the form of disks, regular hexagons, triangles, especially equilateral triangles, and truncated triangles, especially truncated equilateral triangles, or mixtures thereof. They are preferably in the form of disks, truncated triangles, hexagons, or mixtures thereof.

In the context of the present invention, a “surface modified silver nanoplatelet (nanoparticle)” is a silver nanoplatelet (nanoparticle) having attached to its surface one or more surface stabilizing agents and optionally one, or more stabilizing agents.

Accordingly, surface modified silver nanoplatelets bear one, or more surface stabilizing agents described above, or below and optionally one, or more stabilizing agents described above, or below on their surface.

The mean aspect ratio of the silver nanoplatelets is higher than 1.5.

In a preferred embodiment the present invention relates to compositions comprising silver nanoplatelets, the production of which is described in WO2020/083794.

The process described in WO2020/083794 can be used to for the production of
i) compositions comprising silver nanoplatelets, wherein the number mean diameter of the silver nanoplatelets, present in the composition, is in the range of 50 to 150 nm and the number mean thickness of the silver nanoplatelets, present in the composition, is in the range of 5 to 30 nm (a coating, comprising the silver nanoplatelets, shows a turquoise, or blue color in transmission and a yellowish metallic color in reflection); or
ii) compositions comprising silver nanoplatelets, wherein the number mean diameter of the silver nanoplatelets, present in the composition, is in the range of 15 to 35 nm and the number mean thickness of the silver nanoplatelets, present in the composition, is in the range of 5 to 20 nm (a coating, comprising the silver nanoplatelets, shows a brown, or orange color in transmission and a blueish metallic color in reflection); or
iii) compositions comprising silver nanoplatelets, wherein the number mean diameter of the silver nanoplatelets, present in the composition, is in the range of 20 to 70 nm (the standard deviation being less than 50%), the number mean thickness of the silver nanoplatelets, present in the composition, is in the range of 5 to 30 nm (the standard deviation being less than 50%) (a coating, comprising the silver nanoplatelets, shows a magenta color in transmission and a greenish metallic color in reflection).

The number mean diameter of the silver nanoplatelets is preferably in the range of 25 to 65 nm, more preferably 35 to 55 nm. The standard deviation being less than 50%, preferably less than 40%.

The number mean thickness of the silver nanoplatelets is preferably in the range 7 to 25 nm, more preferably 8 to 25 nm. The standard deviation being less than 50%, preferably less than 40%.

The mean aspect ratio (defined as the ratio of mean diameter to mean thickness) being larger than 1.5, preferably larger than 1.6 and more preferably larger than 1.7.

In a more preferred embodiment the mean diameter of the silver nanoplatelets is in the range of 35 to 55 nm with standard deviation being less than 40% and the mean thickness of the silver nanoplatelets is in the range of 8 to 25 nm with standard deviation being less than 40%. The mean aspect ratio of the silver nanoplatelets is higher than 1.7.

The highest wavelength absorption maximum of the population of all silver nanoplatelets in the composition being within the range of 450 to 550 nm, preferably 460 to 540 nm, most preferably 465 to 535 nm (measured in water at ca. 5*10⁻⁵ M (mol/l) concentration of silver).

The absorption maximum has a full width at half maximum (FWHM) value in the range of 20 to 180 nm, preferably 30 to 150 nm, more preferably 35 to 130 nm.

In a particularly preferred embodiment the mean diameter of the silver nanoplatelets is in the range of 40 to 50 nm. The standard deviation being less than 30%. The mean thickness of the silver nanoplatelets is in the range of 15 to 22 nm. The standard deviation being less than 30%. The mean aspect ratio of the silver nanoplatelets is higher than 1.7.

In said embodiment the highest wavelength absorption maximum of the population of all silver nanoplatelets in the composition being within the range of 480 to 500 nm (measured in water at ca. 5*10⁻⁵ M (mol/l) concentration of silver). The absorption maximum has a full width at half maximum (FWHM) value in the range of 70 to 95 nm.

The molar extinction coefficient of silver nanoplatelets, measured at the highest wavelength absorption maximum of the population of all silver nanoplatelets in the composition, is higher than 4000 L/(cm*molAg), especially higher than 5000 L/(cm*molAg), very especially higher than 6000 L/(cm*molAg).

In a preferred embodiment of the present invention the silver nanoplatelets bear one, or more surface stabilizing agents of formula

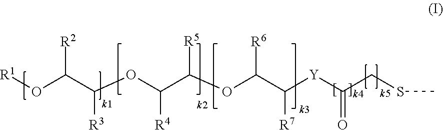

on their surface, wherein indicates the bond to the silver,
R¹ is H, C₁-C₁₈alkyl, phenyl, C₁-C₈alkylphenyl, or CH₂COOH;
R², R³, R₄, R⁵, R⁶ and R⁷ are independently of each other H, C₁-C₈alkyl, or phenyl;
Y is O, or NR⁸;
R⁸ is H, or C₁-C₈alkyl;
k1 is an integer in the range of from 1 to 500,
k2 and k3 are independently of each other 0, or integers in the range of from 1 to 250;
k4 is 0, or 1,
k5 is an integer in the range of from 1 to 5.
Y is preferably O. k4 is preferably 0.

The surface stabilizing agent of formula (I) has preferably a number average molecular weight of from 1000 to 20000, and more preferably from 1000 to 10000, most preferred from 1000 to 6000. All molecular weights specified in this text have the unit of [g/mol] and refer, unless indicated otherwise, to the number average molecular weight (Mn).

If the compounds comprise, for example, ethylene oxide units (EO) and propylene oxide units (PO), the order of (EO) and (PO) may not be fixed (random copolymers).

Preferably, R¹ is H, or C₁-C₁₈alkyl; R², R³, R₄, R⁵, R⁶ and R⁷ are independently of each other H, CH₃, or C₂H₅; k1 is 22 to 450, k2 and k3 are independently of each other 0, or integers in the range of from 1 to 250; k4 is 0, or 1; and k5 is an integer in the range of from 1 to 5.

More preferred, R¹ is H, or C₁-C₄alkyl; R², R³, R₄, R⁵, R⁶ and R⁷ are independently of each other H, or CH₃; k1 is 22 to 450; k2 and k3 are independently of each other 0, or integers in the range of from 8 to 200; k4 is 0; k5 is an integer in the range of from 1 to 4.

The most preferred surface stabilizing agent has the formula

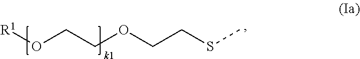

wherein R¹ is H, or a C₁-C₈alkyl group, and k1 is 22 to 450, especially 22 to 150.
R¹ is preferably H, or CH₃.

The most preferred surface stabilizing agents are derived from MPEG thiols (poly(ethylene glycol)methyl ether thiols) having an average Mₙ of 2000 to 6000, such as, for example, MPEG 2000 thiol (A-1, average Mₙ 2,000), MPEG 3000 thiol (A-2), MPEG 4000 thiol (A-3) MPEG 5000 thiol (A-4), MPEG 6000 thiol (A-5), PEG thiols (O-(2-mercaptoethyl)-poly(ethylene glycol)) having an average Mₙ of 2000 to 6000, such as, for example, PEG 2000 thiol (A-6, average Mₙ 2,000), PEG 3000 thiol (A-7), PEG 4000 thiol (A-8), PEG 5000 thiol (A-9), PEG 6000 thiol (A-10).

In addition to the surface stabilizing agents the composition may comprise further stabilization agents. Stabilizing agents may include, for example, phosphines; phosphine oxides; alkyl phosphonic acids; oligoamines, such as ethylenediamine, diethylene triamine, triethylene tetramine, spermidine, spermine; compounds of formula (IIa), (IIb) and (IIc) described below; dendrimers, and salts and combinations thereof.

The stabilizing agent may be a compound of formula R²⁰—X⁴ (IIa), wherein R²⁰ a linear or branched C₁-C₂₅alkyl group, or C₁-C₂₅alkenyl group, which may be substituted by one, or more groups selected from —OH, —SH, —NH₂, or —COOR¹⁹, wherein R¹⁹ is a hydrogen atom, or a C₁-C₂₅alkyl group, and X⁴ is —OH, —SH, —NH₂, or —COOR¹⁹′, wherein R¹⁹′ is a hydrogen atom, a C₁-C₂₅alkyl group, or a C₂-C₂₅alkenyl group, which may be substituted by one, or more groups selected from —OH, —SH, —NH₂, or —COOR¹⁹″, wherein R¹⁹″ is a hydrogen atom, or a C₁-C₂₅alkyl group.

Examples of compounds of formula (IIa) are 1-methylamine, 1-dodecylamine, 1-hexadecylamine, citric acid, oleic acid, D-cysteine, 1-dodecanethiol, 9-mercapto-1-nonanol, 1-thioglycerol, 11-amino-1-undecanethiol, cysteamine, 3-mercaptopropanoic acid, 8-mercaptooctanoic acid and 1,2-ethanedithiol.

The stabilizing agent may be a compound of formula

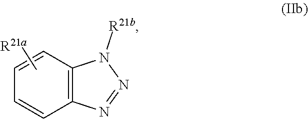

wherein
R^{21a} is a hydrogen atom, a halogen atom, a C₁-C₈alkoxy group, or a C₁-C₈alkyl group,
R^{21b} is a hydrogen atom, or a group of formula —CHR²⁴—N(R²²)(R²³),
R²² and R²³ are independently of each other a C₁-C₈alkyl, a hydroxyC₁-C₈alkyl group, or a group of formula —[(CH₂CH₂)—O]ₙ₁—CH₂CH₂—OH, wherein n1 is 1 to 5, R²⁴ is H or C₁-C₈alkyl.

Examples of compounds of formula (IIb) are

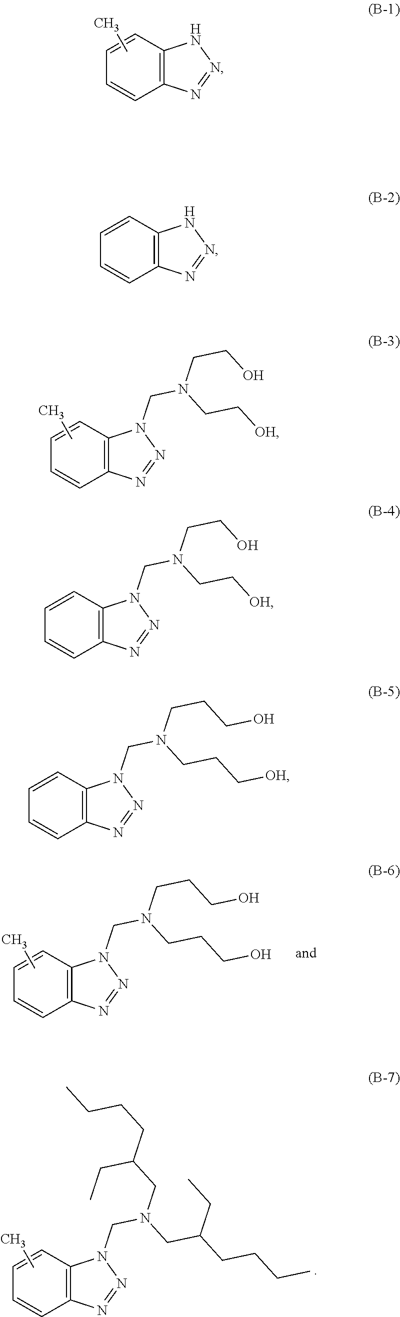

In another preferred embodiment the stabilizing agent is a “polyhydric phenol”, which is a compound, containing an optionally substituted benzene ring and at least 2 hydroxy groups attached to it. The term “polyhydric phenol” comprises polyphenols, such as, for example, tannic acid and polycyclic aromatic hydrocarbons which consist of fused benzene rings, wherein at least one benzene ring has at least 2 hydroxy groups attached to it, such as, for example, 1,2-dihydroxynaphthalene. The “polyhydric phenol” may be substituted. Suitable substituents are described below.

The polyhydric phenol is preferably a compound of formula

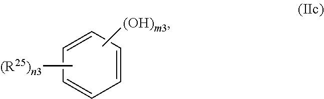

wherein R²⁵ can be the same, or different in each occurrence and is a hydrogen atom, a halogen atom, a C₁-C₁₈alkyl group, a C₁-C₁₈alkoxy group, or a group —C(═O)—R²⁶, R²⁶ is a hydrogen atom, a hydroxy group, a C₁-C₁₈alkyl group, unsubstituted or substituted amino group, unsubstituted or substituted phenyl group, or a C₁-C₁₈alkoxy group, and
n3 is a number of 1 to 4,
m3 is a number of 2 to 4, and
the sum of m3 and n3 is 6.

The polyhydric phenol is more preferably a compound of formula

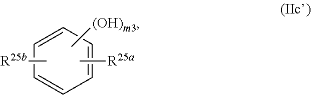

wherein
R^{25a} and R^{25b} are independently of each other a hydrogen atom, a C₁-C₁₈alkyl group, a C₁-C₁₈alkoxy group, or a group of formula —C(═O)—R²⁶,
R²⁶ is a hydrogen atom, a hydroxy group, a C₁-C₁₈alkyl group, an unsubstituted or substituted amino group, unsubstituted or substituted phenyl group, or a C₁-C₁₈alkoxy group, and m3 is a number of 2 to 4, especially 2 to 3. Polyhydric phenols are preferred, which have two hydroxy groups in ortho-position.

Even more preferably, the polyhydric phenol is a compound of formula

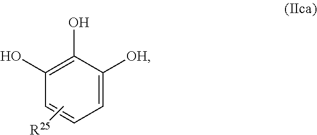

wherein R²⁵ is a hydrogen atom, or a group of formula —C(═O)—R²⁶, wherein R²⁶ is a hydrogen atom, a C₁-C₁₈alkyl group, or a C₁-C₁₈alkoxy group, an unsubstituted or substituted amino group, especially a C₁-C₁₈alkyl group or C₁-C₈alkoxy group.

Most preferred, the polyhydric phenol is a compound of formula

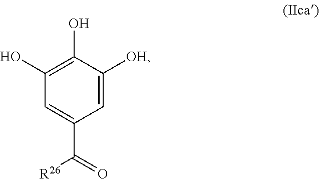

wherein R²⁶ is a hydrogen atom, a C₁-C₁₈alkyl group, or a C₁-C₁₈alkoxy group, especially a C₁-C₈alkoxy group, such as, for example,

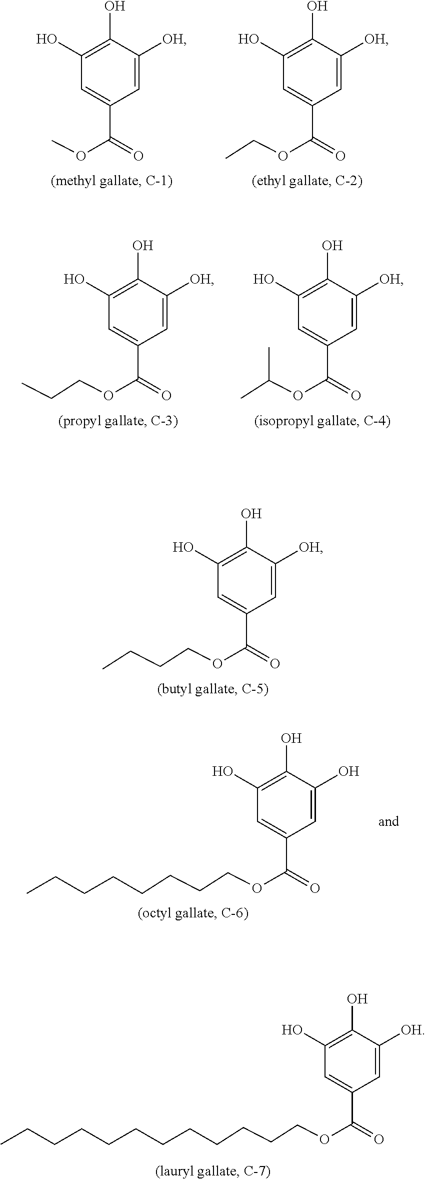

In another preferred embodiment of the present invention the polyhydric phenols are compounds of formula

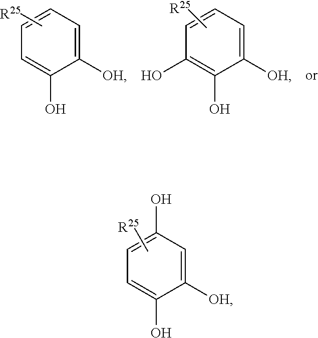

wherein R²⁵ is a hydrogen atom, a C₁-C₁₈alkyl group, or a group of formula —C(═O)—R²⁶, wherein R²⁶ is a hydrogen atom, a hydroxy group, a C₁-C₁₈alkyl group, or a C₁-C₁₈alkoxy group, an unsubstituted or substituted amino group, an unsubstituted or substituted phenyl group, especially a C₁-C₁₈alkyl group or C₁-C₈alkoxy group, such as, for example,

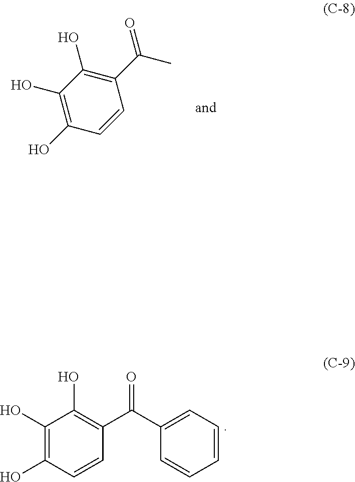 [SMILES: CC(=O)c1ccc(O)c(O)c1O ; O=C(c1ccccc1)c1ccc(O)c(O)c1O]

An unsubstituted or substituted amino group is, for example, a group of formula —NR²⁷R²⁸, wherein R²⁷ and R²⁸ are independently of each other a hydrogen atom, a C₁-C₁₈alkyl group, a phenyl group, preferably a hydrogen atom, or a C₁-C₁₈alkyl group.

In a particularly preferred embodiment the stabilizing agent is selected from compounds of formula (IIb), (IIc), or mixtures thereof.

The most preferred (surface) stabilizing agents (surface stabilizing agents and stabilizing agents), or mixtures thereof are described in WO2020/083794.

In another particularly preferred embodiment the mean diameter of the silver nanoplatelets is in the range of 40 to 50 nm. The standard deviation being less than 30%. The mean thickness of the silver nanoplatelets is in the range of 15 to 22 nm. The standard deviation being less than 30%. The mean aspect ratio of the silver nanoplatelets is higher than 1.7.

In said embodiment the highest wavelength absorption maximum of the population of all silver nanoplatelets in the composition being within the range of 480 to 500 nm (measured in water at ca. 5*10−5 M (mol/l) concentration of silver). The absorption maximum has a full width at half maximum (FWHM) value in the range of 70 to 95 nm.

In said embodiment the silver nanoplatelets preferably bear a surface stabilizing agent of formula

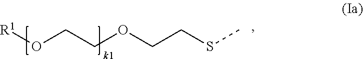

wherein R¹ is H, or a C₁-C₈alkyl group, especially H, or CH₃, and k1 is 22 to 450, especially 22 to 150; especially a compound (A-1), (A-2), (A-3), (A-4), (A-5), (A-6), (A-7), (A-8), (A-9), (A-10), or mixtures thereof, very especially a compound (A-4).

In said embodiment the silver nanoplatelets preferably bear a stabilizing agent of formula (IIb) and optionally a stabilizing agent of formula (IIc). The stabilizing agent of formula (IIb) is especially a compound (B-1), (B-2), (B-3), (B-4), (B-5), (B-6), or (B-7), very especially a compound (B-3). The stabilizing agent of formula (IIc) is especially a compound (C-1), (C-2), (C-3), (C-4), (C-5), (C-6), (C-7), (C-8), or (C-9), very especially a compound (C-2).

In another particularly preferred embodiment the mean diameter of the silver nanoplatelets is in the range of 37 to 47 nm. The standard deviation being less than 30% and the mean thickness of the silver nanoplatelets is in the range of 9 to 15 nm. The standard deviation being less than 30%. The mean aspect ratio of the silver nanoplatelets is higher than 1.7.

In said embodiment the highest wavelength absorption maximum of the population of all silver nanoplatelets in the composition being within the range of 510 to 530 nm (measured in water at ca. 5*10⁻⁵ M (mol/l) concentration of silver). The absorption maximum has a full width at half maximum (FWHM) value in the range of 70 to 90 nm.

In said embodiment the silver nanoplatelets preferably bear a surface stabilizing agent of formula

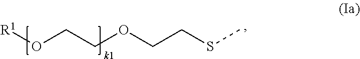

wherein R¹ is H, or a C₁-C₈alkyl group, especially H, or CH₃, and
k1 is 22 to 450, especially 22 to 150; especially a compound (A-1), (A-2), (A-3), (A-4), (A-5), (A-6), (A-7), (A-8), (A-9), (A-10), or mixtures thereof.

In said embodiment the silver nanoplatelets preferably bear a stabilizing agent of formula (IIb) and optionally a stabilizing agent of formula (IIc). The stabilizing agent of formula (IIb) is especially a compound (B-1), (B-2), (B-3), (B-4), (B-5), (B-6), or (B-7), very especially a compound (B-3). The stabilizing agent of formula (IIc) is especially a compound (C-1), (C-2), (C-3), (C-4), (C-5), (C-6), (C-7), (C-8), or (C-9), very especially a compound (C-2).

In another preferred embodiment the composition comprises silver nanoplatelets, wherein the number mean diameter of the silver nanoplatelets, present in the composition, is in the range of 50 to 150 nm with standard deviation being less than 60% and the number mean thickness of the silver nanoplatelets, present in the composition, is in the range of 5 to 30 nm with standard deviation being less than 50%.

The mean aspect ratio of the silver nanoplatelets is higher than 2.0.

The highest wavelength absorption maximum of the population of all silver nanoplatelets in the composition being within the range of 560 to 800 nm.

A coating, comprising the silver nanoplatelets, shows a turquoise, or blue color in transmission and a yellowish metallic color in reflection.

The manufacture of the compositions is described in WO2020/224982.

The mean aspect ratio of the silver nanoplatelets is higher than 2.0.

The surface modified silver nanoplatelets bear a surface modifying agent of formula (V) and optionally further surface stabilizing agents described above, or below on their surface and optionally comprise one, or more stabilizing agents.

The number mean diameter of the silver nanoplatelets is in the range of 50 to 150 nm, preferably 60 to 140 nm, more preferably 70 to 120 nm. The standard deviation being less than 60%, preferably less than 50%.

The number mean thickness of the silver nanoplatelets is in the range of 5 to 30 nm, preferably 7 to 25 nm, more preferably 8 to 25 nm. The standard deviation being less than 50%, preferably less than 30%.

The mean aspect ratio (defined as the ratio of number mean diameter to number mean thickness) being larger than 2.0, preferably larger than 2.2 and more preferably larger than 2.5.

In a particularly preferred embodiment the number mean diameter of the silver nanoplatelets is in the range of 70 to 120 nm. The standard deviation being less than 50% The number mean thickness of the silver nanoplatelets is in the range of 8 to 25 nm. The standard deviation being less than 30%. The mean aspect ratio of the silver nanoplatelets is higher than 2.5.

The highest wavelength absorption maximum of the population of all silver nanoplatelets in the composition being within the range of 560 to 800 nm, preferably 580 to 800 nm, most preferably 600 to 800 nm (measured in water at ca. 5*10⁻⁵ M (mol/l) concentration of silver).

The absorption maximum has a full width at half maximum (FWHM) value in the range of 50 to 500 nm, preferably 70 to 450 nm, more preferably 80 to 450 nm.

The molar extinction coefficient of the silver nanoplatelets, measured at the highest wavelength absorption maximum of the population of all silver nanoplatelets in the composition, is higher than 4000 L/(cm*molAg), especially higher than 5000 L/(cm*molAg), very especially higher than 6000 L/(cm*molAg).

In a preferred embodiment of the present invention the silver nanoplatelets bear a surface stabilizing agent of formula (I) described above on their surface.

A surface stabilizing agent of formula

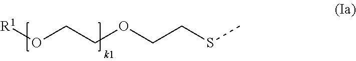

preferred, wherein R¹ is H, or a C₁-C₈alkyl group, and
k1 is 22 to 450, especially 22 to 150. R¹ is preferably H, or CH₃.

is more

The most preferred surface stabilizing agents are derived from MPEG thiols (poly(ethylene glycol)methyl ether thiols) having an average Mₙ of 2000 to 6000, such as, for example, MPEG 2000 thiol (A-1, average Mₙ 2,000), MPEG 3000 thiol (A-2), MPEG 4000 thiol (A-3) MPEG 5000 thiol (A-4), MPEG 6000 thiol (A-5), PEG thiols (O-(2-mercaptoethyl)-poly(ethylene glycol)) having an average Mₙ of 2000 to 6000, such as, for example, PEG 2000 thiol (A-6, average Mₙ 2,000), PEG 3000 thiol (A-7), PEG 4000 thiol (A-8), PEG 5000 thiol (A-9), PEG 6000 thiol (A-10).

In another preferred embodiment the silver nanoplatelets bear a surface stabilizing agent which is a polymer, or copolymer described in WO200674969, which can be obtained by a process comprising the steps
i1) polymerizing in a first step one or more ethylenically unsaturated monomers in the presence of at least one nitroxylether having the structural element

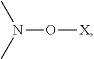

wherein X represents a group having at least one carbon atom and is such that the free radical X· derived from X is capable of initiating polymerization; or
i2) polymerizing in a first step one or more ethylenically unsaturated monomers in the presence of at least one stable free nitroxyl radical

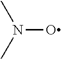

and a free radical initiator;
wherein at least one monomer used in the steps i1) or i2) is a C₁-C₆ alkyl or hydroxy C₁-C₆ alkyl ester of acrylic or methacrylic acid; and optionally
ii) a second step, comprising the modification of the polymer or copolymer prepared under
i1) or i2) by a transesterification reaction, an amidation, hydrolysis or anhydride modification or a combination thereof.

The monomer in step i1) or i2) is preferably selected from 4-vinyl-pyridine or pyridinium-ion, 2-vinyl-pyridine or pyridinium-ion, 1-vinyl-imidazole or imidazolinium-ion, or a compound of formula CH₂═C(Rₐ)—(C═Z)—R_{b}, wherein R^{a} is hydrogen or methyl, R_{b} is NH₂, O—(Me⁺), unsubstituted C₁-C₁₈alkoxy, C₂-C₁₀₀alkoxy interrupted by at least one N and/or O atom, or hydroxy-substituted C₁-C₁₈alkoxy, unsubstituted C₁-C₁₈alkylamino, unsubstituted di(C₁-C₁₈alkyl)amino, hydroxy-substituted C₁-C₁₈alkylamino or hydroxy-substituted di(C₁-C₁₈alkyl)amino, —O—(CH₂)_{y}NR¹⁵R¹⁶, or —O—(CH₂)_{y}NHR¹⁵R¹⁶⁺ An⁻, —N—(CH₂)_{y}NR¹⁵R¹⁶, or —N—(CH₂)_{y}NHR¹⁵R¹⁶⁺ An⁻, wherein
An⁻ is an anion of a monovalent organic, or inorganic acid;
y is an integer from 2 to 10;
R¹⁵ is saturated or unsaturated, linear or branched chain alkyl with 1-22 carbon atoms,
R¹⁶ is saturated or unsaturated, linear or branched chain alkyl with 1-22 carbon atoms,
Me is a monovalent metal atom or the ammonium ion.
Z is oxygen or sulfur.

The second step ii) is preferably a transesterification reaction.

In step ii) the alcohol is preferably an ethoxylate of formula

R_{A}—[O—CH₂—CH₂-]ₙ₁-OH (A), wherein R_{A} is saturated or unsaturated, linear or branched chain alkyl with 1-22 carbon atoms, or alkylaryl or dialkylaryl with up to 24 carbon atoms and n1 is 1 to 150.

Preferably, step i1) or i2) is carried out twice and a block copolymer is obtained wherein in the first or second radical polymerization step the monomer or monomer mixture contains 50 to 100% by weight, based on total monomers, of a C₁-C₆ alkyl ester of acrylic or methacrylic acid and in the second or first radical polymerization step respectively, the ethylenically unsaturated monomer or monomer mixture contains at least a monomer without primary or secondary ester bond.

In the first polymerization step the monomer or monomer mixture contains from 50 to 100% by weight based on total monomers of a C₁-C₆ alkyl ester of acrylic or methacrylic acid (first monomer) and in the second polymerization step the ethylenically unsaturated monomer or monomer mixture comprises 4-vinyl-pyridine or pyridinium-ion, 2-vinyl-pyridine or pyridinium-ion, vinyl-imidazole or imidazolinium-ion, 3-dimethylaminoethylacrylamide, 3-dimethylaminoethylmethacrylamide, or corresponding ammonium ion, 3-dimethylaminopropylacrylamide, or corresponding ammonium ion, or 3-dimethylaminopropylmethacrylamide, or corresponding ammonium ion (second monomer).

The nitroxylether is preferably a compound of formula

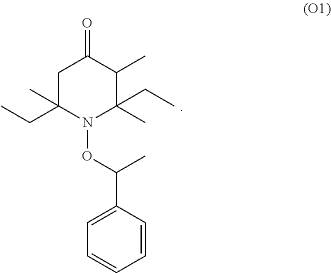 [SMILES: CCC1(C)CC(=O)C(C)C(C)(CC)N1OC(C)c1ccccc1]

The surface stabilizing agent is preferably a copolymer which can be obtained by a process comprising the steps
i1) polymerizing in a first step a first monomer, which is a C₁-C₆ alkyl or hydroxy C₁-C₆ alkyl ester of acrylic or methacrylic acid, and a second monomer which is selected from selected from 4-vinyl-pyridine or pyridinium-ion, 2-vinyl-pyridine or pyridinium-ion, 1-vinyl-imidazole or imidazolinium-ion, 3-dimethylaminoethylacrylamide, 3-dimethylaminoethylmethacrylamide 3-dimethylaminopropylacrylamide, and 3-dimethylaminopropylmethacrylamide; in the presence of at least one nitroxylether having the structural element

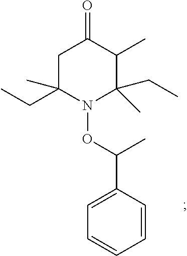 [SMILES: CCC1(C)CC(=O)C(C)C(C)(CC)N1OC(C)c1ccccc1]

and
ii) a second step, comprising the modification of the polymer or copolymer prepared under i) or ii) by a transesterification reaction, wherein the alcohol in step ii) is an ethoxylate of formula

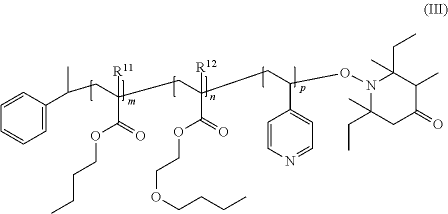

wherein
R_{A} is saturated or unsaturated, linear or branched chain alkyl with 1-22 carbon atoms, or alkylaryl or dialkylaryl with up to 24 carbon atoms and n1 is 1 to 150.

Copolymers represented by formula

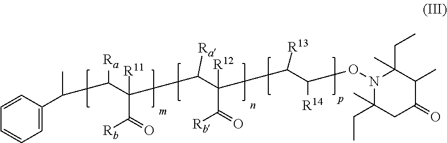

are preferred, wherein
R¹¹ and R¹² are H or methyl,
R¹³, Rₐ and Rₐ′ are independently of each other H or methyl,
R_{b} is saturated or unsaturated, linear or branched chain alkyl with 1-22 carbon atoms,
R_{b}′ is R_{A}—[O—CH₂—CH₂-]ₙ₁—O—,
R¹⁴ is

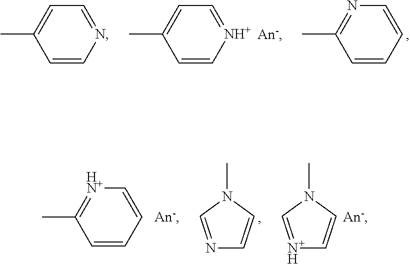

—C(═O)—N—(CH₂)_{y}NR¹⁵R¹⁶, or —C(═O)—N—(CH₂)_{y}NHR¹⁵R¹⁶⁺ An⁻,
wherein
An⁻ is an anion of a monovalent organic, or inorganic acid;
y is an integer from 2 to 10;
R¹⁵ is saturated or unsaturated, linear or branched chain alkyl with 1-22 carbon atoms,
R¹⁶ is saturated or unsaturated, linear or branched chain alkyl with 1-22 carbon atoms,
R_{A} is saturated or unsaturated, linear or branched chain alkyl with 1-22 carbon atoms, or alkylaryl or dialkylaryl with up to 24 carbon atoms and n1 is 1 to 150,
m, n and p are independently of each other integers from 1 to 200, and
is an integer from 1 to 150.

Copolymers represented by formula

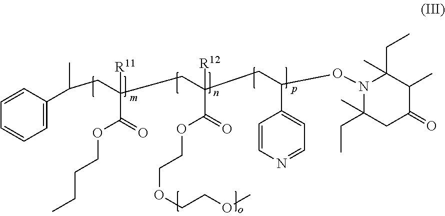

are more preferred, where R¹¹ and R¹² are H or methyl, m, n and p are independently of each other integers from 1 to 200, o is an integer from 1 to 150, especially an integer from 1 to 149. The order of monomers with indices m and n may be fixed (block copolymers) or not fixed (random copolymers).

Examples of preferred copolymers are the copolymers described in Example A3 (D-1), Example A6 (D-2) of WO200674969.

In a particularly preferred embodiment the silver nanoplatelets comprise one, or more surface stabilizing agents of formula (I) and one, or more surface stabilizing agents of formula (III).

In addition to the surface stabilizing agents the composition may further comprise stabilizing agents. Stabilizing agents may include, for example, phosphines; phosphine oxides; alkyl phosphonic acids; oligoamines, such as ethylenediamine, diethylene triamine, triethylene tetramine, spermidine, spermine; compounds of formula (IIa), (IIb), (IIc) and (IId) described above; surfactants; dendrimers, and salts and combinations thereof.

The stabilizing agent may be a compound of formula R²⁰—X⁴ (IIa), wherein R²⁰ and X⁴ are defined above.

Examples of compounds of formula (IIa) are 1-methylamine, 1-dodecylamine, 1-hexadecylamine, citric acid, oleic acid, D-cysteine, 1-dodecanethiol, 9-mercapto-1-nonanol, 1-thioglycerol, 11-amino-1-undecanethiol, cysteamine, 3-mercaptopropanoic acid, 8-mercaptooctanoic acid and 1,2-ethanedithiol.

The stabilizing agent may be a compound of formula

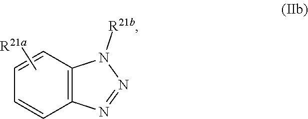

wherein R^{21a} and R^{21b} are defined above. Examples of compounds of formula (IIb) are compounds (B-1), (B-2), (B-3), (B-4), (B-5), (B-6) and (B-7).

In another preferred embodiment the stabilizing agent is a “polyhydric phenol”, which is defined above. The polyhydric phenol is preferably a compound of formula

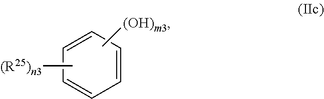

wherein R²⁵, n3 and m3 are defined above, more a compound of formula

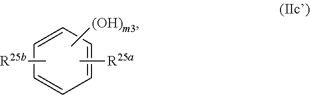

wherein m3, R^{25a} and R^{25b} are defined above.

Even more preferably, the polyhydric phenol is a compound of formula

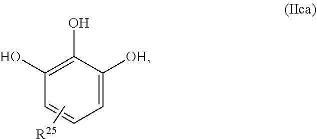

wherein R²⁵ is defined above.

Most preferred, the polyhydric phenol is a compound of formula

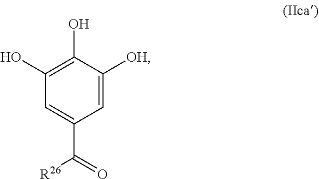

wherein R²⁶ is a hydrogen atom, a C₁-C₁₈alkyl group, or a C₁-C₁₈alkoxy group, especially a C₁-C₈alkoxy group, such as, for example, methyl gallate (C-1), ethyl gallate (C-2), propyl gallate (C-3), isopropyl gallate (C-4), butyl gallate (C-5), octyl gallate (C-6) and lauryl gallate (C-7).

In another preferred embodiment of the present invention the polyhydric phenols are compounds of formula

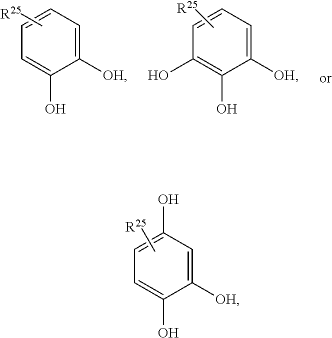

wherein R²⁵ is a hydrogen atom, a C₁-C₁₈alkyl group, or a group of formula —C(═O)—R²⁶, wherein R²⁶ is a hydrogen atom, a hydroxy group, a C₁-C₁₈alkyl group, or a C₁-C₁₈alkoxy group, an unsubstituted or substituted amino group, an unsubstituted or substituted phenyl group, especially a C₁-C₁₈alkyl group or C₁-C₈alkoxy group, such as, for example, a compound (C-8) and (C-9).

In a particularly preferred embodiment the stabilizing agent is selected from compounds of formula (IIb), (IIc), or mixtures thereof.

In a particularly preferred embodiment the silver nanoplatelets comprise one, or more surface stabilizing agents of formula (I) and one, or more surface stabilizing agents of formula (III). In addition, the silver nanoplatelet compositions may comprise one, or more stabilizing agents of formula (IIb).

Processes for producing the composition according to the present invention are, for example, described in WO2020/083794 and WO2020/224982.

### (B) Reactive Diluents

Reactive diluents are generally described in P. K. T. Oldring (ed.), Chemistry & Technology of UV & EB Formulations for Coatings, Inks & paints, Vol. II, Chapter III: Reactive Diluents for UV & EB Curable Formulations, Wiley and SITA technology, London 1997.

A “reactive diluent” is a component that contains at least one free radically reactive group (e.g., an ethylenically-unsaturated group) that can co-react with components (C) (e.g., is capable of undergoing addition polymerization).

The reactive diluent (B) may comprise two different types of radically polymerizable ethylenically unsaturated groups in one molecule, for example, acrylate and methacrylate, acrylate and acrylamide, or acrylate and vinyl ester groups.

The reactive diluent (B) is a relatively low molecular weight compound having a weight average molecular weight MW less than 800 g/mol.

The reactive diluent (B) may be a single diluent, or a mixture of two, or more diluents.

If the composition of the present invention comprises the reactive diluent(s) (B), it is contained in an amount of 2 to 40% by weight, preferably 5 to 35% by weight, more preferably 7 to 30% by weight based on the total weight of the composition.

The composition of the present invention may contain a monofunctional, difunctional, trifunctional, or tetrafunctional diluent having one, two, three, or four unsaturated carbon-carbon bonds.

The reactive diluent B may be an epoxyacrylate selected from reaction products of (meth)acrylic acid with aromatic glycidyl ethers or aliphatic glycidyl ethers. Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), and tris[4-(2,3-epoxypropoxy)phenyl]methane isomers (CAS No. [66072-39-7]). Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410-58-7]).

The reactive diluent (B) is preferably selected from monofunctional (meth)acrylates, difunctional (meth)acrylates, trifunctional (meth)acrylates, tetrafunctional (meth)acrylates, pentafunctional (meth)acrylates, hexafunctional (meth)acrylates, monofunctional vinylamides, monofunctional vinyl esters, monofunctional (meth)acrylamides, di(meth)acrylamides, divinyl esters, divinyl amide, trimethylolpropane formal (meth)acrylates, N-vinyloxazolidinones, N-Vinyl-caprolactam (NVC) and N-Vinyl-pyrrolidone (NVP) and mixtures thereof.

An example of monofunctional vinyl esters is 1-hexanoic acid vinyl ester.

Examples of monofunctional vinylamides include N-vinyl-pyrrolidone, N-vinylcaprolactame, N-(hydroxymethyl) vinylamide, N-hydroxyethyl vinylamide, N-isopropylvinylamide, N-isopropylmethvinylamide, N-tert-butylvinylamide, N,N′-methylenebisvinylamide, N-(isobutoxymethyl) vinylamide, N-(butoxymethyl) vinylamide, N-[3-(dimethylamino)propyl]methvinylamide, N,N-dimethylvinylamide, N,N-diethylvinylamide and N-methyl-N-vinylacetamide.

Examples of monofunctional (meth)acrylamides include acryloylmorpholine, methacryloylmorpholine, N-(hydroxymethyl) acrylamide, N-hydroxyethyl acrylamide, N-isopropylacrylamide, N-isopropylmethacrylamide, N-tert-butylacrylamide, N,N′-methylenebisacrylamide, N-(isobutoxymethyl) acrylamide, N-(butoxymethyl) acrylamide, N-[3-(dimethylamino)propyl]methacrylamide, N,N-dimethylacrylamide, N,N-diethylacrylamide, N-(hydroxymethyl) methacrylamide, N-hydroxyethyl methacrylamide, N-isopropylmethacrylamide, N-isopropylmethmethacrylamide, N-tert-butylmethacrylamide, N-(isobutoxymethyl) methacrylamide, N-(butoxymethyl) methacrylamide, N-[3-(dimethylamino)propyl]methmethacrylamide, N,N-dimethylmethacrylamide and N,N-diethylmethacrylamide.

Further examples of a monofunctional diluent are N-vinyloxazolidinones of formula

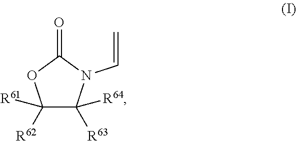

wherein
R⁸¹, R⁸², R⁶³ and R⁸⁴ are independently of each other a hydrogen atom or an organic group having not more than 10 carbon atoms, such as, for example, N-vinyloxazolidinone (NVO), or N-vinyl-5-methyl oxazolidinone (NVMO);
N-Vinyl-pyrrolidone (NVP), N-Vinyl-caprolactam (NVC), trimethylolpropane formal (meth)acrylates, such as, for example,

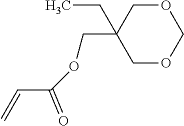

(trimethylolpropane formal acrylate)

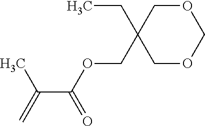

(trimethylolpropane formal methacrylate);
di(meth)acrylamides of formula

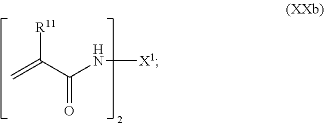

wherein
R¹¹ is independently in each occurrence H, or a methyl group,
X¹ is a group of formula

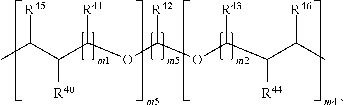

wherein
m1 is 0, or 1; m2 is 0, or 1;
m3 is 0, or an integer of 1 to 10; m4 is 0, or an integer of 1 to 10;
m5 is 0, or an integer 1 to 8;
R⁴² is independently in each occurrence H, or a C₁-C₄alkyl group;
R⁴⁰, R⁴¹, R⁴³, R⁴⁴, R⁴⁵ and R⁴⁶ are independently of each other H, or a C₁-C₄alkyl group; divinyl esters of formula

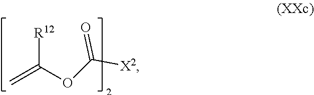

such as, for example, divinyl adipate, succinic acid divinyl ester, and
divinyl amides of formula

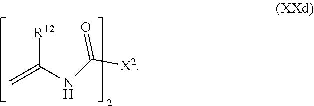

R¹² is independently in each occurrence H, or a methyl group,
X² is a group of formula

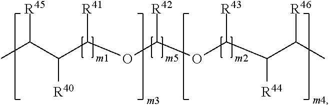

wherein
m1 is 0, or 1; m2 is 0, or 1;
m3 is 0, or an integer of 1 to 10; m4 is 0, or an integer of 1 to 10;
m5 is 0, or an integer 1 to 8;
R⁴² is independently in each occurrence H, or a C₁-C₄alkyl group;
R⁴⁰, R⁴¹, R⁴³, R⁴⁴, R⁴⁵ and R⁴⁶ are independently of each other H, or a C₁-C₄alkyl group.

The reactive diluent (B) is preferably selected from monofunctional (meth)acrylates, difunctional (meth)acrylates, trifunctional (meth)acrylates, tetrafunctional (meth)acrylates, pentafunctional (meth)acrylates, hexafunctional (meth)acrylates, divinyl esters and mixtures thereof.

Examples of monofunctional (meth)acrylates include without limitation octyl acrylate; decyl acrylate; lauryl acrylate, tridecyl acrylate; isodecyl acrylate; stearyl acrylate, 2-(2-ethoxyethoxy)ethyl acrylate, octyl methacrylate, lauryl methacrylate, isodecyl methacrylate, tridecyl methacrylate; tetradecyl methacrylate; isodecyl methacrylate and stearyl methacrylate, 3,3,5-trimethylcyclohexyl acrylate; isobornyl acrylate; 4-tert-butylcyclohexyl acrylate; cyclohexylmethacrylate, isobornyl methacrylate, tetrahydrofurfuryl acrylate, (5-ethyl-1,3-dioxan-5-yl)methyl acrylate, ethoxylated phenyl acrylate, ethoxylated phenyl methacrylate, nonyl phenol acrylate, nonyl phenol methacrylate, methoxy polyethyleneglycol acrylates, methoxy polyethyleneglycol methacrylates, methoxy polypropyleneglycol acrylates, methoxy polypropyleneglycol methacrylates, tetrahydrofurfuryl methacrylate, cyclic trimethylolpropane formal methacrylate, hydroxyethyl acrylate, hydroxypropyl acrylate and glycidyl acrylate, N-(2-hydroxyethyl) acrylate, hydroxyethyl methacrylate, hydroxypropyl methacrylate and glycidyl methacrylate, benzyl acrylate, 2-phenoxyethyl acrylate, ethoxylated (EO4) phenol acrylate; mixtures of ethoxylated (EO4) phenol acrylate and ethoxylated (EO8)nonylphenol acrylate; propoxylated (PO2)nonylphenol acrylate, ethoxylated o-phenylphenol acrylate, p-cumylphenoxylethyl acrylate, dicyclopentenyl acrylate and dicyclopentenyloxyethyl acrylate and 2-(N-butylcarbamoyloxy)ethyl acrylate.

The monofunctional (meth)acrylates may include hydroxyethyl acrylate, hydroxypropyl acrylate and glycidyl acrylate, N-(2-hydroxyethyl) acrylate, hydroxyethyl methacrylate, hydroxypropyl methacrylate, benzyl acrylate and glycidyl methacrylate.

Examples of the difunctional (meth)acrylate are bisphenol A ethoxylate diacrylate, bisphenol A glycerolate diacrylate, glycerol diacrylate, triglycerol diacrylate, poly(ethylene glycol)-block-poly(propylene glycol)-block-poly(ethylene glycol) diacrylate, tricyclo[5.2.1.02,6]decanedimethanol diacrylate, (ethoxylated)trimethylolpropane methyl ether diacrylate, (propoxylated)trimethylolpropane methyl ether diacrylate, cyclohexanediol diacrylate, cyclohexanedimethanol diacrylate, cyclohexanedimethanol diacrylate, bisphenol A ethoxylate dimethacrylate, bisphenol A glycerolate dimethacrylate, glycerol dimethacrylate, triglycerol dimethacrylate, poly(ethylene glycol)-block-poly(propylene glycol)-block-poly(ethylene glycol) dimethacrylate, tricyclo[5.2.1.02,6]decanedimethanol dimethacrylate, (ethoxylated)trimethylolpropane methyl ether dimethacrylate, (propoxylated)trimethylolpropane methyl ether dimethacrylate, cyclohexanediol dimethacrylate and cyclohexanedimethanol dimethacrylate.

The difunctional (meth)acrylate is preferably a compound of formula

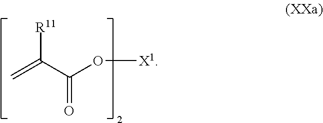

R¹¹ is independently in each occurrence H, or a methyl group;
X¹ is a group of formula

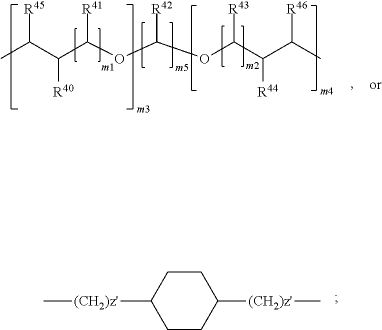

wherein
m1 is 0, or 1; m2 is 0, or 1;
m3 is 0, or an integer of 1 to 10; m4 is 0, or an integer of 1 to 10;
m5 is 0, an integer 1 to 8;
z is 0, or 1;
R⁴² is independently in each occurrence H, or a C₁-C₄alkyl group;
R⁴⁰, R⁴¹, R⁴³, R⁴⁴, R⁴⁵ and R⁴⁶ are independently of each other H, or a C₁-C₄alkyl group.

Examples of difunctional (meth)acrylates of formula (XXa) are propylene glycol diacrylate, dipropylene glycol diacrylate, tripropylene glycol diacrylate, tetrapropylene glycol diacrylate, ethylene glycol diacrylate, diethylene glycol diacrylate, triethylene glycol diacrylate, tetraethylene glycol diacrylate, 1,3-propanediol diacrylate, 1,2-butanediol diacrylate, 1,3-butanediol diacrylate, 1,4-butanediol diacrylate, pentanediol diacrylate, hexanediol diacrylate, (ethoxylated) 1,4-butanediol diacrylate, (propoxylated) 1,4-butanediol diacrylate, (ethoxylated) 1,5-pentanediol diacrylate, (propoxylated) 1,5-pentanediol diacrylate, (ethoxylated) 1,6-hexanediol diacrylate, (propoxylated) 1,6-hexanediol diacrylate, (ethoxylated) 1,8-octanediol diacrylate, (propoxylated) 1,8-octanediol diacrylate, (ethoxylated)neopentyl glycol diacrylate, (propoxylated)neopentyl glycol diacrylate, propylene glycol dimethacrylate, dipropylene glycol dimethacrylate, tripropylene glycol dimethacrylate, tetrapropylene glycol dimethacrylate, ethylene glycol dimethacrylate, diethylene glycol dimethacrylate, triethylene glycol dimethacrylate, tetraethylene glycol dimethacrylate, 1,3-propanediol dimethacrylate, 1,2-butanediol dimethacrylate, 1,3-butanediol dimethacrylate, 1,4-butanediol dimethacrylate, pentanediol dimethacrylate, hexanediol dimethacrylate, (ethoxylated) 1,4-butanediol dimethacrylate, (propoxylated) 1,4-butanediol dimethacrylate, (ethoxylated) 1,5-pentanediol dimethacrylate, (propoxylated) 1,5-pentanediol dimethacrylate, (ethoxylated) 1,6-hexanediol dimethacrylate, (propoxylated) 1,6-hexanediol dimethacrylate, (ethoxylated) 1,8-octanediol dimethacrylate, (propoxylated) 1,8-octanediol dimethacrylate, (ethoxylated)neopentyl glycol dimethacrylate, (propoxylated)neopentyl glycol dimethacrylate, polyethylene glycol diacrylate, polyethyleneglycol dimethacrylate, poly(propylene glycol) diacrylate, poly(propylene glycol) dimethacrylate.

Examples of trifunctional (meth)acrylates are trimethylolpropane triacrylate (TMPTA), trimethylolpropane trimethacrylate (TMPTMA), ethoxylated trimethylolpropane triacrylates (in particular selected from the group consisting of ethoxylated (EO3)trimethylolpropane triacrylates, ethoxylated (EO6)trimethylolpropane triacrylates, ethoxylated (EO9)trimethylolpropane triacrylates), propoxylated trimethylolpropane triacrylates (PO3 TMPTA), ethoxylated glycerol triacrylates and propoxylated glycerol triacrylates (GPTA), pentaerythritol triacrylates (PETA), a mixture of pentaerythritol triacrylate and tetraacrylate, ethoxylated pentaerythritol triacrylates, propoxylated pentaerythritol triacrylates (ethoxylated (EO3) pentaerythritol triacrylates, ethoxylated (EO6) pentaerythritol triacrylates, ethoxylated (EO9) pentaerythritol triacrylates) and mixtures thereof.

Examples of tetrafunctional (meth)acrylates are bistrimethylolpropane tetraacrylate (DiTMPTA), pentaerythritol tetracrylate (PETA), tetramethylolmethane tetramethacrylate, pentaerythritol tetramethacrylate, bistrimethylolpropane tetraacrylate, bistrimethylolpropane tetramethacrylate, ethoxylated bistrimethylolpropane tetraacrylate, propoxylated bistrimethylolpropane tetraacrylate, ethoxylated pentaerythritol tetraacrylate (EPETA), propoxylated pentaerythritol tetraacrylate, dipentaerythritol tetraacrylate, ethoxylated dipentaerythritol tetraacrylate, propoxylated dipentaerythritol tetraacrylate and mixtures thereof.

Examples of pentafunctional (meth)acrylates are dipentaerythritol pentaacrylate, sorbitol pentaacrylate and mixtures thereof.

Examples of hexafunctional (meth)acrylates are dipentaerythritol hexaacrylate, EBECRYL® 1290, which is a hexafunctional aliphatic urethane hexaacrylate and mixtures thereof.

More preferably the reactive diluent (B) is selected from divinyladipate, dipropylene glycol diacrylate, tripropylene glycol diacrylate, dipropylene glycol dimethacrylate, tripropylene glycol dimethacrylate, diethylene glycol diacrylate, triethylene glycol diacrylate, diethylene glycol dimethacrylate, triethylene glycol dimethacrylate, butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, cyclohexanediol diacrylate, cyclohexanediol dimethacrylate, cyclohexanedimethanol diacrylate, cyclohexanedimethanol dimethacrylate, (ethoxylated)neopentyl glycol diacrylate, (propoxylated)neopentyl glycol diacrylate, (ethoxylated)neopentyl glycol dimethacrylate, (propoxylated)neopentyl glycol dimethacrylate, trimethylolpropane triacrylate (TMPTA), trimethylolpropane trimethacrylate (TMPTMA), ethoxylated trimethylolpropane triacrylates, ethoxylated trimethylolpropane trimethacrylates, propoxylated trimethylolpropane triacrylates, propoxylated trimethylolpropane trimethacrylates, ethoxylated glycerol triacrylates, ethoxylated glycerol trimethacrylates,
propoxylated glycerol triacrylates, propoxylated glycerol trimethacrylates, bistrimethylolpropane tetraacrylate, bistrimethylolpropane tetramethacrylate, ethoxylated bistrimethylolpropane tetraacrylates, propoxylated bistrimethylolpropane tetraacrylates, pentaerythritol tetraacrylate, pentaerythritol tetramethacrylate, ethoxylated pentaerythritol tetraacrylates, ethoxylated pentaerythritol tetramethacrylates, propoxylated pentaerythritol tetraacrylates, propoxylated pentaerythritol tetramethacrylates, dipentaerythritol hexaacrylate, ethoxylated dipentaerythritol hexaacrylates, propoxylated dipentaerythritol hexaacrylates and mixtures thereof.

### Oligomer (C)

Radically curable oligomers as used herein refers to relatively high molecular weight polymeric compounds having a weight average molecular weight (MW) higher than about 800 g/mol. The weight average molecular weights described herein are determined by GPC (gel permeation chromatography).

The radically curable oligomers (C) are preferably (meth)acrylate oligomers which may be branched or essentially linear, and the (meth)acrylate functional group or groups, respectively, can be terminal groups and/or pendant side groups bonded to the oligomer backbone. The term “(meth)acrylate” in the context of the present invention refers to the acrylate as well as the corresponding methacrylate. Preferably, the radically curable oligomers are (meth)acrylic oligomers, urethane (meth)acrylate oligomers, polyester (meth)acrylate oligomers, polyether based (meth)acrylate oligomers, amine modified polyether based (meth)acrylate oligomers or epoxy (meth)acrylate oligomers, more preferably urethane (meth)acrylate oligomers and epoxy (meth)acrylate oligomers. The functionality of the oligomer is not limited but is preferably not greater than 3.

The oligomer (C) is preferably selected from (meth)acrylic oligomers, urethane (meth)acrylate oligomers, polyester (meth)acrylate oligomers, polyether based (meth)acrylate oligomers, amine modified polyether based (meth)acrylate oligomers or epoxy (meth)acrylate oligomers, more preferably urethane (meth)acrylate oligomers, polyester (meth)acrylate oligomers, polyether based (meth)acrylate oligomers, and epoxy (meth)acrylate oligomers and mixtures thereof.

Suitable examples of urethane (meth)acrylate oligomers include aliphatic urethane (meth)acrylate oligomers, in particular diacrylates, triacrylates, tetraacrylates and hexaacrylates, such as those sold by Sartomer under the grade number starting with CN90, CN92, CN93, CN94, CN95, CN96, CN98, CN99 and those sold by Allnex under the designation Ebecryl® 225, 230, 242, 244, 245, 246, 264, 265, 266, 267, 271, 280/15IB, 284, 286, 294/25HD, 1258, 1291, 4101, 4141, 4201, 4250, 4220, 4265, 4396, 4397, 4491, 4513, 4666, 4680, 4683, 4738, 4740, 4820, 4858, 4859, 5129, 81 10, 8209, 8254, 8296, 8307, 8402, 8465 and 8602; and aromatic (meth)acrylate oligomers, in particular diacrylates, triacrylates, tetraacrylates and hexaacrylates, such as those sold by Sartomer under the grade number starting with CN91 (except CN910A70) and grades starting with CN97 and those sold by Allnex under the designations Ebecryl® 204, 205,206, 210, 214, 215, 220, 2221, 4501, 6203, 8232 and 8310. The urethane (meth)acrylate oligomers may be based upon polyethers or polyesters, which are reacted with aromatic, aliphatic, or cycloaliphatic diisocyanates and capped with hydroxy acrylates. Particularly suitable aliphatic urethane (meth)acrylate oligomers are sold by Rahn under the designation Genomer® 4316 and particularly suitable aromatic urethane (meth)acrylate oligomers are sold by Allnex under the designation Ebercryl® 2003.

Suitable examples of epoxy (meth)acrylate oligomers include without limitation aliphatic epoxy (meth)acrylate oligomers, in particular monoacrylates, diacrylates and triacrylates, and aromatic epoxy (meth)acrylate oligomers, in particular bisphenol-A (meth)acrylate oligomers, such as those sold by Sartomer under the grade number starting with 104, 109.1XX as well as CN2003EU, UVE150/80 and UVE151 M; such as those sold by Allnex under the designation Ebecryl® 600, 604, 605, 609, 641, 646, 648, 812, 1606, 1608, 3105, 3300, 3203, 3416, 3420, 3608, 3639, 3700, 3701, 3702, 3703, 3708, 3730, 3740, 5848, 6040.

In a preferred embodiment of the present invention the oligomer (C) is an urethane (meth)acrylate (C) which is obtainable by reaction of the following components:
(a) at least one isocyanate having two isocyanate groups,
(b) at least one polyalkylene oxide polyether having at least 2 hydroxyl groups,
(c) at least one hydroxy-functional (meth)acrylate having one hydroxyl group and one (meth)acrylate group,
(d) at least one compound having at least one isocyanate reactive group and at least one acid function,
(e) at least one basic compound which is present for neutralization or partial neutralization of the acid groups of component (d),
(f) optionally at least one monoalcohol having one hydroxy function.

The production of the urethane (meth)acrylate (C) can be done in the presence of at least one reactive diluent.

Preferably, the isocyanate component (a) is added to a mixture of components (b), (c) and (d).

### Component (a)

Aromatic diisocyanates are preferred and include naphthylene 1.5-diisocyanate (NDI), tolylene 2,4- and/or 2,6-diisocyanate (TDI), diphenylmethane 2,2′-, 2,4′- and/or 4,4′-diisocyanate (MDI), 3,3′-dimethyl-4,4′-diisocyanato-diphenyl (TODI), p-phenylene diisocyanate (PDI), diphenylethan-4,4′-diisoyanate (EDI), diphenylmethandiisocyanate, 3,3′-dimethyl-diphenyl-diisocyanate, 1,2-diphenylethandiisocyanate and/or phenylene diisocyanat.

4,4′-, 2,4′- and/or 2,2′-methylenedicyclohexyl diisocyanate (H12MDI), isophorone diisocyanates (IPDI), and tolylene 2,4- and/or 2,6-diisocyanate (TDI) are preferred. TDI is most preferred.

### Component (b)

Preferred components (b) are polyalkylene ether with 2 hydroxy groups, which are essentially, preferably exclusively formed from ethylene oxide and/or propylene oxide. Such compounds are often referred to as polyethylene/propylene glycols or polyalkylene glycols.

The structure of the polyalkylene glycols is generally as follows HO—[—X₁-]ₙ₄-H, wherein X₁ for each i=1 to n4 independently of each other is selected from —CH₂—CH₂—O—, —CH₂—CH(CH₃)—O— and —CH(CH₃)—CH₂—O—, especially-CH₂—CH₂—O— and n4 is an integer from 5 to 60 can, preferably 10 to 45 and more preferably 7 to 50.

The number average molecular weight Mₙ may range preferably from 500 and 2000 g/mol. The OH numbers (53240 DIN, potentiometric) are preferably in a range of about 20 to 300 mg KOH/g of polymer.

### Component (c)

The hydroxyalkylacrylate, or hydroxyalkylmethacrylate (A1) is preferably a compound of formula

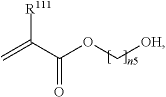

wherein R¹¹¹ is a hydrogen atom, or a methyl group, and n5 is 2 to 6, especially 2 to 4. Examples of (A1) include 2-hydroxyethyl acrylate, 2-hydroxyethyl methacrylate, 2- or 3-hydroxypropyl acrylate, 2- or 3-hydroxypropyl methacrylate, 4-hydroxybutyl methacrylate and 4-hydroxybutyl acrylate. 2-Hydroxyethyl acrylate is most preferred.

### Component (d)

The component (d) comprises at least one, e.g. 1 to 3, more preferably 2 to 3 and most preferably exactly 2 isocyanate-reactive groups and at least one, preferably one, or two acid function.

The acid groups are preferably carboxylic acid groups.

The isocyanate-reactive groups are selected from hydroxyl, mercapto, primary and/or secondary amino groups. Hydroxy groups are preferred.

As compounds (d) mercaptoacetic acid (thioglycolic acid), mercaptopropionic acid, mercaptosuccinic acid, hydroxyacetic acid, hydroxypropionic acid (lactic acid), 2-hydroxysuccinic acid, hydroxypivalic acid, dimethylolpropionic acid, dimethylolbutyric acid, hydroxydecanoic acid, hydroxydodecanoic acid, 12-hydroxystearic acid, glycine (aminoacetic acid),

Dimethylolbutyric acid is preferred and dimethylolpropionic acid is especially preferred.

### Component (e)

At least one, preferably one basic compound is present for neutralization or partial neutralization of the acid groups of component (d).

Examples of basic compounds (e) are inorganic and organic bases such as alkali and alkaline earth metal hydroxides, oxides, carbonates, bicarbonates and ammonia or tert-amines. Preferably the neutralization or partial neutralization is done with sodium hydroxide or potassium hydroxide or tert-amines, such as triethylamine, tri-n-butylamine or ethyl diisopropylamine. The amount of introduced chemically bonded acid groups and the degree of neutralization of the acid groups (which is usually 40 to 100% of the equivalent basis) should preferably be sufficient to ensure the dispersion of the polyurethane in an aqueous medium, which is known in the art.

### Component (f)

The component (f) is a monoalcohol having exactly one hydroxy function and comprising no further functional group.

Examples of the optional component (f) are methanol, ethanol, n-propanol, isopropanol and n-butanol.

The function of the compounds (f) is, in the preparation of the urethane (meth)acrylates (C) to saturate any remaining, unreacted isocyanate groups.

The preparation of the urethane (meth)acrylate (C) can be done in the presence of a reactive diluent.

Preferred compounds reactive diluents have one to four, preferably one two to four, more preferably two (meth)acrylate groups.

Particularly preferred reactive diluents have a boiling point higher than 200° C. at atmospheric pressure. Examples are the reactive diluents comprising 1 to 4 (meth)acrylate groups (B) described above. The same preferences apply as with respect to the reactive diluent (B). In case the preparation of the urethane (meth)acrylate (C) is done in the presence of a reactive diluent (B), the obtained urethane (meth)acrylate (C) already contains reactive diluent (B), which is preferably selected from dipropylene glycol diacrylate, tripropylene glycol diacrylate, dipropylene glycol dimethacrylate, tripropylene glycol dimethacrylate, diethylene glycol diacrylate, triethylene glycol diacrylate, diethylene glycol dimethacrylate, triethylene glycol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, cyclohexanediol diacrylate, cyclohexanediol dimethacrylate and cyclohexanedimethanol diacrylate. Dipropylene glycol diacrylate is most preferred.

### D) Photoinitiator

Examples of photoinitiators are known to the person skilled in the art and for example published by Kurt Dietliker in “A compilation of photoinitiators commercially available for UV today”, Sita Technology Textbook, Edinburgh, London, 2002 and include aminoketones (e.g. alpha-aminoketones), hydroxyketones (e.g. alpha-hydroxyketones), alkoxyketones (e.g. alpha-alkoxyketones), acetophenones, benzophenones, ketosulfones, benzyl ketals, benzoin ethers, phosphine oxides, phenylglyoxylates, and thioxanthones.

A suitable example of ketosulfone includes 1-[4-(4-benzoylphenylsulfanyl)phenyl]-2-methyl-2-(4-methylphenylsulfonyl)propan-1-one.

A suitable example of benzyl ketals includes 2,2-dimethoxy-2-phenylacetophenone.

Suitable examples of benzoin ethers include without limitation 2-ethoxy-1,2-diphenylethanone; 2-isopropoxy-1,2-diphenylethanone; 2-isobutoxy-1,2-diphenylethanone (CAS no. 22499 Dec. 3); 2-butoxy-1,2-diphenylethanone; 2,2-dimethoxy-1,2-diphenylethanone; and 2,2-diethoxyacetophenone.

Examples of suitable acylphosphine oxide compounds are of the formula XII

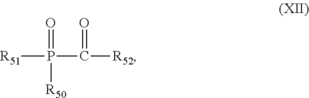

wherein
R⁵⁰ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR⁵³R⁵⁴;
or R⁵⁰ is unsubstituted C₁-C₂₀alkyl or is C₁-C₂₀alkyl which is substituted by one or more halogen, C₁-C₁₂alkoxy, C₁-C₁₂alkylthio, NR⁵³R⁵⁴ or by—(CO)—O—C₁-C₂₄alkyl;
R⁵¹ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR⁵³R⁵⁴; or R⁵¹ is —(CO) R′52; or R⁵¹ is C₁-C₁₂alkyl which is unsubstituted or substituted by one or more halogen, C₁-C₁₂alkoxy, C₁-C₁₂alkylthio, or by NR⁵³R⁵⁴;
R⁵² and R′52 independently of each other are unsubstituted cyclohexyl, cyclopentyl, phenyl, naphthyl or biphenylyl, or are cyclohexyl, cyclopentyl, phenyl, naphthyl or biphenylyl substituted by one or more halogen, C₁-C₄alkyl or C₁-C₄alkoxy; or R⁵² is a 5- or 6-membered heterocyclic ring comprising an S atom or N atom;
R⁵³ and R⁵⁴ independently of one another are hydrogen, unsubstituted C₁-C₁₂alkyl or C₁-C₁₂alkyl substituted by one or more OH or SH wherein the alkyl chain optionally is interrupted by one to four oxygen atoms; or R⁵³ and R⁵⁴ independently of one another are C₂-C₁₂-alkenyl, cyclopentyl, cyclohexyl, benzyl or phenyl;
Specific examples are bis(2,4,6-trimethylbenzoyl)-phenylphosphine oxide; 2,4,6-trimethylbenzoyl-diphenyl-phosphine oxide; ethyl (2,4,6 trimethylbenzoyl phenyl) phosphinic acid ester; (2,4,6-trimethylbenzoyl)-2,4-dipentoxyphenylphosphine oxide, bis(2,6-dimethoxybenzoyl)-2,4,4-trimethylpentylphosphine oxide.

Interesting further are mixtures of the compounds of the formula XII with compounds of the formula XI as well as mixtures of different compounds of the formula XII.

Examples are mixtures of bis(2,6-dimethoxybenzoyl)-2,4,4-trimethylpentylphosphine oxide with 1-hydroxy-cyclohexyl-phenyl-ketone, of bis(2,4,6-trimethylbenzoyl)-phenylphosphine oxide with 2-hydroxy-2-methyl-1-phenyl-propan-1-one, of bis(2,4,6-trimethylbenzoyl)-phenylphosphine oxide with ethyl (2,4,6 trimethylbenzoyl phenyl) phosphinic acid ester, etc. Examples of suitable benzophenone compounds are compounds of the formula X:

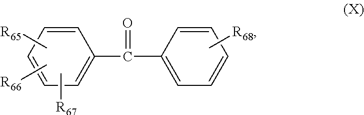

wherein
R₆₅, R₆₆ and R₆₇ independently of one another are hydrogen, C₁-C₄alkyl, C₁-C₄-halogenalkyl, C₁-C₄alkoxy, CI or N(C₁-C₄alkyl)₂;
R₆₈ is hydrogen, C₁-C₄alkyl, C₁-C₄halogenalkyl, phenyl, N(C₁-C₄alkyl)₂, COOCH₃,

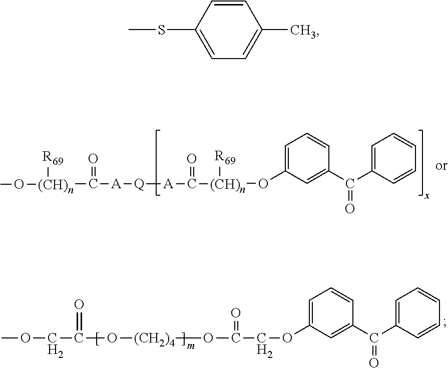

Q is a residue of a polyhydroxy compound having 2 to 6 hydroxy groups;
x is a number greater than 1 but no greater than the number of available hydroxyl groups in Q;
A is —[O(CH₂)_{b}CO]_{y}— or —[O(CH₂)_{b}CO]_{(y-1)}—[O(CHR⁷¹CHR⁷⁰)ₐ]_{y}—;
R₆₉ is hydrogen, methyl or ethyl; and if N is greater than 1 the radicals R₆₉ may be the same as or different from each other;
a is a number from 1 to 2;
b is a number from 4 to 5;
y is a number from 1 to 10;
n is; and
m is an integer 2-10.

Specific examples are benzophenone, a mixture of 2,4,6-trimethylbenzophenone and 4-methylbenzophenone, 4-phenylbenzophenone, 4-methoxybenzophenone, 4,4′-dimethoxybenzophenone, 4,4′-dimethylbenzophenone, 4,4′-dichlorobenzophenone, 4,4′-dimethylaminobenzophenone, 4,4′-diethylaminobenzophenone, 4-methylbenzophenone, 4-(4-methylthiophenyl)benzophenone, 3,3′-dimethyl-4-2,4,6-trimethylbenzophenone, methoxybenzophenone, methyl-2-benzoylbenzoate, 4-(2-hydroxyethylthio)benzophenone, 4-(4-tolylthio)benzophenone, 4-benzoyl-N,N,N-trimethylbenzenemethanaminium chloride, 2-hydroxy-3-(4-benzoylphenoxy)-N,N,N-trimethyl-1-propanaminium chloride monohydrate, 4-(13-acryloyl-1,4,7,10,13-pentaoxatridecyl)benzophenone, 4-benzoyl-N,N-dimethyl-N-[2-(1-oxo-2-propenyl)oxy]ethylbenzenemethanaminium chloride; [4-(2-hydroxy-ethylsulfanyl)-phenyl]-(4-isopropylphenyl)-methanone; biphenyl-[4-(2-hydroxy-ethylsulfanyl)-phenyl]-methanone; biphenyl-4-yl-phenyl-methanone; biphenyl-4-yl-p-tolyl-methanone; biphenyl-4-yl-m-tolyl-methanone; [4-(2-hydroxy-ethylsulfanyl)-phenyl]-p-tolyl-methanone; [4-(2-hydroxy-ethylsulfanyl)-phenyl]-(4-isopropyl-phenyl)-methanone; [4-(2-hydroxy-ethylsulfanyl)-phenyl]-(4-methoxy-phenyl)-methanone; 1-(4-benzoyl-phenoxy)-propan-2-one; [4-(2-hydroxy-ethylsulfanyl)-phenyl]-(4-phenoxy-phenyl)-methanone; 3-(4-benzoyl-phenyl)-2-dimethylamino-2-methyl-1-phenyl-propan-1-one; (4-chloro-phenyl)-(4-octylsulfanyl-phenyl)-methanone; (4-chloro-phenyl)-(4-dodecylsulfanyl-phenyl)-methanone; (4-bromo-phenyl)-(4-octylsulfanyl-phenyl)-methanone; (4-dodecylsulfanyl-phenyl)-(4-methoxy-phenyl)-methanone; (4-benzoyl-phenoxy)-acetic acid methyl ester; biphenyl-[4-(2-hydroxy-ethylsulfanyl)-phenyl]-methanone; 1-[4-(4-benzoylphenylsulfanyl)phenyl]-2-methyl-2-(4-methylphenylsulfonyl)propan-1-one.

Examples of suitable alpha-hydroxy ketone, alpha-alkoxyketone or alpha-aminoketone compounds are of the formula (XI)

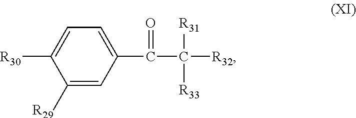

wherein
R₂₉ is hydrogen or C₁-C₁₈alkoxy;
R₃₀ is hydrogen, C₁-C₁₈alkyl, C₁-C₁₂hydroxyalkyl, C₁-C₁₈alkoxy, OCH₂CH₂—OR₃₄, morpholino, S—C₁-C₁₈alkyl, a group —HC═CH₂, —C(CH₃)═CH₂,

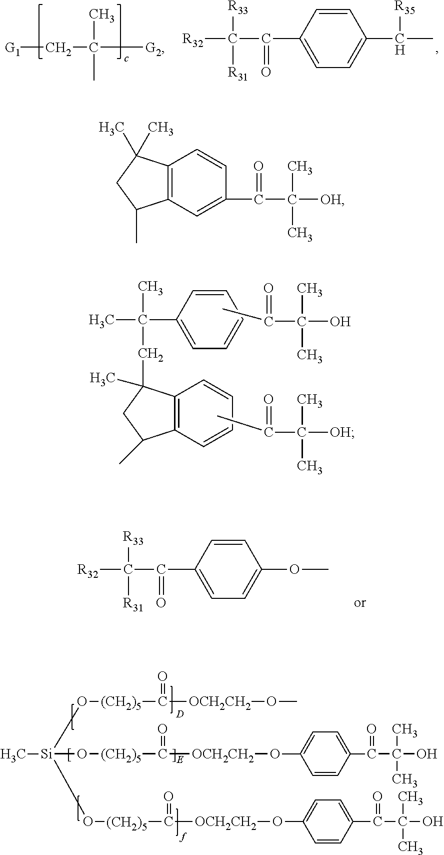

d, e and f are 1-3;
c is 2-10;
G₁ and G₂ independently of one another are end groups of the polymeric structure, preferably hydrogen or methyl;
R₃₄ is hydrogen,

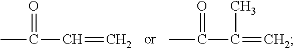

R₃₁ is hydroxy, C₁-C₁₆alkoxy, morpholino, dimethylamino or —O(CH₂CH₂O) g-C₁-C₁₆alkyl;
g is 1-20;
R₃₂ and R₃₃ independently of one another are hydrogen, C₁-C₆alkyl, C₁-C₁₆alkoxy or —O(CH₂CH₂O) g-C₁-C₁₆alkyl; or are unsubstituted phenyl or benzyl; or phenyl or benzyl substituted by C₁-C₁₂-alkyl; or R₃₂ and R₃₃ together with the carbon atom to which they are attached form a cyclohexyl ring;
R₃₅ is hydrogen, OR₃₆ or NR³⁷R₃₈;
R₃₆ is hydrogen, C₁-C₁₂alkyl which optionally is interrupted by one or more non-consecutive O-atoms and which uninterrupted or interrupted C₁-C₁₂alkyl optionally is substituted by one or more OH,
or R₃₆ is

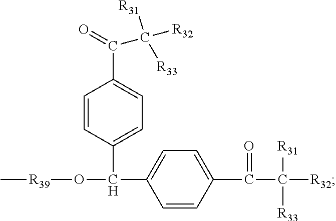

R₃₇ and R₃₈ independently of each other are hydrogen or C₁-C₁₂alkyl which is unsubstituted or is substituted by one or more OH;
R₃₉ is C₁-C₁₂alkylene which optionally is interrupted by one or more non-consecutive O, —(CO)—NH—C₁-C₁₂alkylene-NH—(CO)— or

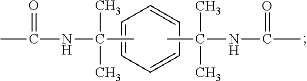

with the proviso that R₃₁, R₃₂ and R₃₃ not all together are C₁-C₁₆alkoxy or —O(CH₂CH₂O) g-C₁-C₁₆alkyl.

Specific examples are 1-hydroxy-cyclohexyl-phenyl-ketone (optionally in admixture with benzophenone), 2-methyl-1 [4-(methylthio)phenyl]-2-morpholinopropan-1-one, 2-benzyl-2-dimethylamino-1-(4-morpholinophenyl)-butan-1-one, 2-dimethylamino-2-(4-methyl-benzyl)-1-(4-morpholin-4-yl-phenyl)-butan-1-one, (3,4-dimethoxy-benzoyl)-1-benzyl-1-di-methylamino propane, 1-[4-(2-hydroxyethoxy)-phenyl]-2-hydroxy-2-methyl-1-propan-1-one, 2,2-dimethoxy-1,2-diphenylethan-1-one, 2-hydroxy-2-methyl-1-phenyl-propan-1-one, 2-hydroxy-1-{4-[4-(2-hydroxy-2-methyl-propionyl)-benzyl]-phenyl}-2-methyl-propan-1-one, 2-hydroxy-1-{4-[4-(2-hydroxy-2-methyl-propionyl)-phenoxy]-phenyl}-2-methyl-propan-1-one, 2-hydroxy-1-{1-[4-(2-hydroxy-2-methyl-propionyl)-phenyl]-1,3,3-trimethyl-indan-5-yl}-2-methyl-propan-1-one.

Examples of suitable phenylglyoxylate compounds are of the formula XIII

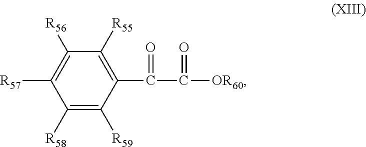

wherein
R₆₀ is hydrogen, C₁-C₁₂alkyl or

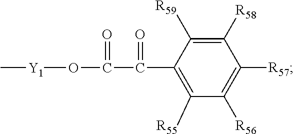

R₅₅, R₅₆, R₅₇, R₅₈ and R₅₉ independently of one another are hydrogen, unsubstituted C₁-C₁₂alkyl or C₁-C₁₂alkyl substituted by one or more OH, C₁-C₄alkoxy, phenyl, naphthyl, halogen or by CN; wherein the alkyl chain optionally is interrupted by one or more oxygen atoms; or
R₅₅, R₅₆, R₅₇, R₅₈ and R₅₉ independently of one another are C₁-C₄alkoxy, C₁-C₄alkythio or NR⁵²R₅₃;
R₅₂ and R₅₃ independently of one another are hydrogen, unsubstituted C₁-C₁₂alkyl or C₁-C₁₂alkyl substituted by one or more OH or SH wherein the alkyl chain optionally is interrupted by one to four oxygen atoms; or R₅₂ and R₅₃ independently of one another are C₂-C₁₂-alkenyl, cyclopentyl, cyclohexyl, benzyl or phenyl; and
Y₁ is C₁-C₁₂alkylene optionally interrupted by one or more oxygen atoms.

Specific examples of the compounds of the formula XIII are oxo-phenyl-acetic acid 2-[2-(2-oxo-2-phenyl-acetoxy)-ethoxy]-ethyl ester, methyl a-oxo benzeneacetate. Examples of suitable oxime ester compounds are of the formula XIV

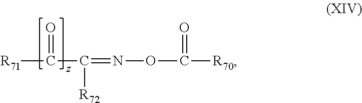

wherein z is 0 or 1;
R₇₀ is hydrogen, C₃-C₈cycloalkyl; C₁-C₁₂alkyl which is unsubstituted or substituted by one or more halogen, phenyl or by CN; or R₇₀ is C₂-C₈alkenyl; phenyl which is unsubstituted or substituted by one or more C₁-C₆alkyl, halogen, CN, OR₇₃, SR₇₄ or by NR⁷⁵R₇₆; or R₇₀ is C₁-C₈alkoxy, benzyloxy; or phenoxy which is unsubstituted or substituted by one or more C₁-C₆alkyl or by halogen;
R₇₁ is phenyl, naphthyl, benzoyl or naphthoyl, each of which is substituted by one or more halogen, C₁-C₁₂alkyl, C₃-C₈cycloalkyl, benzyl, phenoxycarbonyl, C₂-C₁₂alkoxycarbonyl, OR₇₃, SR₇₄, SOR⁷⁴, SO2R₇₄ or by NR⁷⁵R₇₆, wherein the substituents OR₇₃, SR₇₄ and NR⁷⁵R₇₆ optionally form 5- or 6-membered rings via the radicals R₇₃, R₇₄, R₇₅ and/or R₇₆ with further substituents on the phenyl or naphthyl ring; or each of which is substituted by phenyl or by phenyl which is substituted by one or more OR₇₃, SR₇₄ or by NR⁷⁵R₆₆; or R₇₁ is thioxanthyl, or

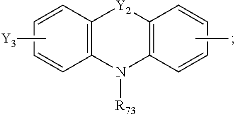

R₇₂ is hydrogen; unsubstituted C₁-C₂₀alkyl or C₁-C₂₀alkyl which is substituted by one or more halogen, OR₇₃, SR₇₄, C₃-C₈cycloalkyl or by phenyl; or is C₃-C₈cycloalkyl; or is phenyl which is unsubstituted or substituted by one or more C₁-C₈alkyl, phenyl, halogen, OR₇₃, SR₇₄ or by NR⁷⁵R₇₆; or is C₂-C₂₀alkanoyl or benzoyl which is unsubstituted or substituted by one or more C₁-C₈alkyl, phenyl, OR₇₃, SR₇₄ or by NR⁷⁵R₇₆; or is C₂-C₁₂alkoxycarbonyl, phenoxycarbonyl, CN, CONR⁷⁵R₇₆, NO₂, C₁-C₄haloalkyl, S(O)_{y}—C₁-C₈alkyl, or S(O)_{y}-phenyl,
y is 1 or 2;
Y₂ is a direct bond or no bond;
Y₃ is NO₂ or

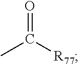

R₇₃ and R₇₄ independently of one another are hydrogen, C₁-C₂₀alkyl, C₂-C₁₂alkenyl, C₃-C₈cycloalkyl, C₃-C₈cycloalkyl which is interrupted by one or more, preferably 2, O, phenyl-C₁-C₈alkyl; or are C₁-C₈alkyl which is substituted by OH, SH, CN, C₁-C₈alkoxy, C₁-C₈alkanoyl, C₃-C₈cycloalkyl, by C₃-C₈cycloalkyl which is interrupted by one or more O, or which C₁-C₈alkyl is substituted by benzoyl which is unsubstituted or substituted by one or more C₁-C₆alkyl, halogen, OH, C₁-C₄alkoxy or by C₁-C₄alkylsulfanyl; or are phenyl or naphthyl, each of which is unsubstituted or substituted by halogen, C₁-C₁₂alkyl, C₁-C₁₂alkoxy, phenyl-C₁-C₈alkyloxy, phenoxy, C₁-C₁₂alkylsulfanyl, phenylsulfanyl, N(C₁-C₁₂alkyl)₂, diphenylamino or by

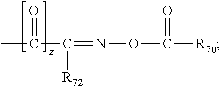

R₇₅ and R₇₆ independently of each other are hydrogen, C₁-C₂₀alkyl, C₂-C₄hydroxyalkyl, C₂-C₁₀alkoxyalkyl, C₂-C₈alkenyl, C₃-C₈cycloalkyl, phenyl-C₁-C₈alkyl, C₁-C₈alkanoyl, C₃-C₁₂alkenoyl, benzoyl; or are phenyl or naphthyl, each of which is unsubstituted or substituted by C₁-C₁₂alkyl, benzoyl or by C₁-C₁₂alkoxy; or R₇₅ and R₇₆ together are C₂-C₈alkylene optionally interrupted by O or NR⁷³ and optionally are substituted by hydroxyl, C₁-C₄alkoxy, C₂-C₄alkanoyloxy or by benzoyloxy;
R₇₇ is C₁-C₁₂alkyl, thienyl or phenyl which is unsubstituted or substituted by C₁-C₁₂alkyl, OR₇₃, morpholino or by N-carbazolyl.

Specific examples are 1,2-octanedione 1-[4-(phenylthio)phenyl]-2-(O-benzoyloxime), ethanone 1-[9-ethyl-6-(2-methylbenzoyl)-9H-carbazol-3-yl]-1-(O-acetyloxime), 9H-thioxanthene-2-carboxaldehyde 9-oxo-2-(O-acetyloxime), ethanone 1-[9-ethyl-6-(4morpholinobenzoyl)-9H-carbazol-3-yl]-1-(O-acetyloxime), ethanone 1-[9-ethyl-6-(2-methyl-4-(2-(1,3-dioxo-2-dimethyl-cyclopent-5-yl) ethoxy)—benzoyl)-9H-carbazol-3-yl]-1-(O-acetyloxime) (Adeka N-1919), ethanone 1-[9-ethyl-6-nitro-9H-carbazol-3-yl]-1-[2-methyl-4-(1-methyl-2-methoxy) ethoxy)phenyl]-1-(O-acetyloxime) (Adeka NCI831), etc.

In certain cases it may be of advantage to use mixtures of two or more photoinitiators.

In a particularly preferred embodiment the compositions of the present invention comprise at least one radical photoinitiator, which can be activated by irradiation with UV light in the range of 300 to 400 nm, especially 310 to 340 nm.

The photonitiator (D) is preferably a compound of the formula

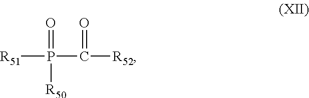

wherein
R₅₀ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR⁵³R₅₄;
or R₅₀ is unsubstituted C₁-C₂₀alkyl or is C₁-C₂₀alkyl which is substituted by one or more halogen, C₁-C₁₂alkoxy, C₁-C₁₂alkylthio, NR⁵³R₅₄ or by—(CO)—O—C₁-C₂₄alkyl;
R₅₁ is unsubstituted cyclohexyl, cyclopentyl, phenyl, naphthyl or biphenylyl; or is cyclohexyl, cyclopentyl, phenyl, naphthyl or biphenylyl substituted by one or more halogen, C₁-C₁₂alkyl, C₁-C₁₂alkoxy, C₁-C₁₂alkylthio or by NR⁵³R₅₄; or R₅₁ is —(CO) R′52; or R₅₁ is C₁-C₁₂alkyl which is unsubstituted or substituted by one or more halogen, C₁-C₁₂alkoxy, C₁-C₁₂alkylthio, or by NR₅₃R₅₄;
R₅₂ and R′52 independently of each other are unsubstituted cyclohexyl, cyclopentyl, phenyl, naphthyl or biphenylyl, or are cyclohexyl, cyclopentyl, phenyl, naphthyl or biphenylyl substituted by one or more halogen, C₁-C₄alkyl or C₁-C₄alkoxy; or R₅₂ is a 5- or 6-membered heterocyclic ring comprising an S atom or N atom;
R₅₃ and R₅₄ independently of one another are hydrogen, unsubstituted C₁-C₁₂alkyl or C₁-C₁₂alkyl substituted by one or more OH or SH wherein the alkyl chain optionally is interrupted by one to four oxygen atoms; or R₅₃ and R₅₄ independently of one another are C₂-C₁₂-alkenyl, cyclopentyl, cyclohexyl, benzyl or phenyl, or the photoinitiator (C) is a compound of the formula

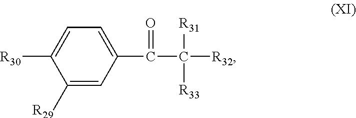

wherein
R₂₉ is hydrogen or C₁-C₁₈alkoxy;
R₃₀ is hydrogen, C₁-C₁₈alkyl, C₁-C₁₂hydroxyalkyl, C₁-C₁₈alkoxy, OCH₂CH₂—OR₃₄, morpholino, S—C₁-C₁₈alkyl, a group —HC═CH₂, —C(CH₃)═CH₂,

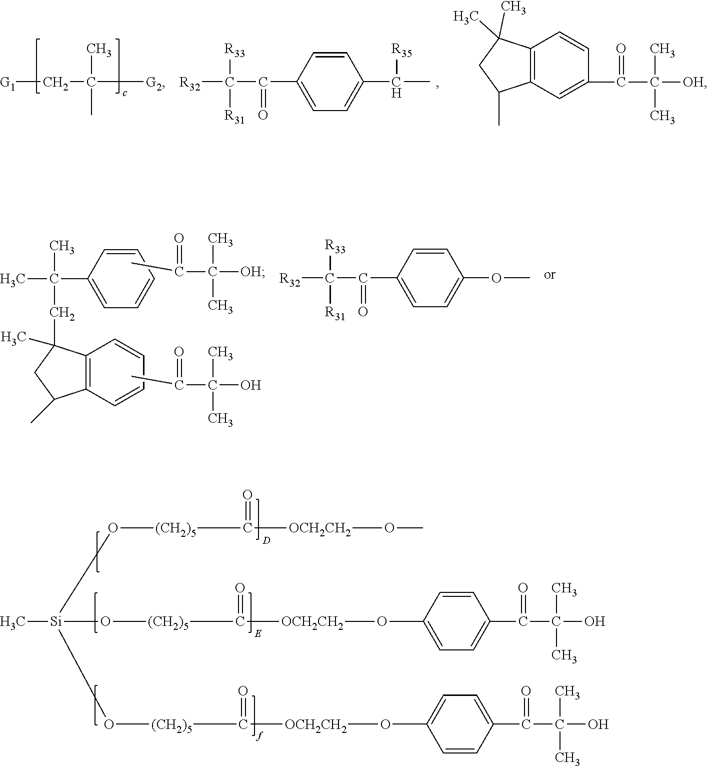

D, E and f are 1-3;
c is 2-10;
G₁ and G₂ independently of one another are end groups of the polymeric structure, preferably hydrogen or methyl;
R₃₄ is hydrogen,

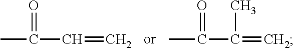

R₃₁ is hydroxy, C₁-C₁₆alkoxy, morpholino, dimethylamino or —O(CH₂CH₂O) g-C₁-C₁₆alkyl;
g is 1-20;
R₃₂ and R₃₃ independently of one another are hydrogen, C₁-C₆alkyl, C₁-C₁₆alkoxy or —O(CH₂CH₂O) g-C₁-C₁₆alkyl; or are unsubstituted phenyl or benzyl; or phenyl or benzyl substituted by C₁-C₁₂-alkyl; or R₃₂ and R₃₃ together with the carbon atom to which they are attached form a cyclohexyl ring;
R₃₅ is hydrogen, OR₃₆ or NR₃₇R₃₈;
R₃₆ is hydrogen, C₁-C₁₂alkyl which optionally is interrupted by one or more non-consecutive O-atoms and which uninterrupted or interrupted C₁-C₁₂alkyl optionally is substituted by one or more OH,
or R₃₆ is

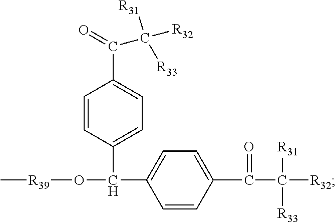

R₃₇ and R₃₈ independently of each other are hydrogen or C₁-C₁₂alkyl which is unsubstituted or is substituted by one or more OH;
R₃₉ is C₁-C₁₂alkylene which optionally is interrupted by one or more non-consecutive O, —(CO)—NH—C₁-C₁₂alkylene-NH—(CO)— or

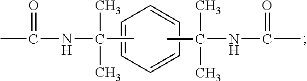

with the proviso that R₃₁, R₃₂ and R₃₃ not all together are C₁-C₁₆alkoxy or —O(CH₂CH₂O) g-C₁-C₁₆alkyl, or the photoinitiator is a mixture of different compounds of the formula (XII), or the photoinitiator is a mixture of compounds of the formula (XII) and (XI).

### Surfactant (E)

The surfactant (E) may be a compound, containing perfluoroalkyl, perfluoroalkenyl and/or perfluoropolyether segment(s) in the molecule, said surfactant being capable to reduce the surface energy of the composition according to the present invention.

Examples of the surfactant (E) are
a (per)fluoropolyether polymer described in WO2020/084054, such as, for example, a polymer of formula

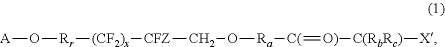

R_{f} is a (per)fluoropolyoxyalkylene chain having an average number molecular weight
Mₙ ranging from 100 to 8,000, preferably from 300 to 6,000, more preferably from 800 to 3,000, and comprising, preferably consisting of, repeating units, which may be equal to or different from one another, selected from:
(i)—CFY′O—, wherein Y′ is F or CF₃,
(ii) —CFY′CFY′O—, wherein Y′, equal or different at each occurrence, is as above defined, with the proviso that at least one of Y′ is —F,
(iii) —CF₂CF₂CW₂O—, wherein each of W, equal or different from each other, are F or H,

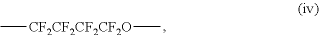

(v) —(CF₂); —CFZ′—O—wherein j is an integer from 0 to 3 and Z′ is a group of general formula —OR_{f}′T, wherein R_{f}′ is a fluoropolyoxyalkene chain comprising a number of repeating units from 0 to 10, said recurring units being chosen among the followings:—CFY′O—, —CF₂CFY″O—, —CF₂CF₂CF₂O—, —CF₂CF₂CF₂CF₂O—, with each of each of Y″ being independently F or CF₃ and T being a C₁-C₃ perfluoroalkyl group;
Z is fluorine or CF₃;
x is 0 or 1, with the proviso that, when, x is 1, Z is F; —Rₐ is a polyoxyalkylene chain free from fluorine atoms, said chain comprising from 4 to 50 fluorine-free oxyalkylene units, said units being the same or different from one another and being selected from —CH₂CH₂O—and —CH₂CH(J)O—, wherein J is a straight or branched alkyl or aryl, preferably methyl, ethyl or phenyl
R_{b} and R_{b} are independently a hydrogen, a methyl or a benzyl group, with the proviso that R_{b} and R_{c} cannot be both hydrogen;
X′ is a chlorine, a bromine or a iodine atom, preferably a bromine atom;
A is —Rₐ—C(═O)—C(R_{b}R_{c})—X′, wherein Rₐ, R_{b}, R_{c}, and X′ are as defined above, or is a straight or branched C₁-C₄ (per)fluoroalkyl group wherein one fluorine atom can be substituted by one chlorine atom or one hydrogen atom, such as, for example, a polymer of formula Rx [CF₂CH₂O—(CH₂CH₂O), —C(═O)—C(CH₃)₂—Br]2 (n′=0 to 6);
a surfactant of formula R_{f1}—C₂H₄-SO₃Cat (2), wherein R_{f1} represents a perfluorinated aliphatic group and Cat represents a cation, which have been disclosed in U.S. Pat. Nos. 5,789,508, 4,025,709, 5,688,884 and 4,380,618;
a partially fluorinated surfactant of the general formula R″_{f}—(CH₂)ₘ₆—R′—COOY¹ (3), wherein
R″_{f} represents a perfluoroalkyl group or a perfluoroalkoxy group of 3 to 8 carbon atoms, R′_{f} represents a perfluoroalkylene of 1 to 4 carbon atoms, Y₁ is NH₄, Li, Na, K or H, or a linear, branched or cyclic alkyl containing 1-8 carbon atoms, and m6 is 1-3, described in U.S. Pat. No. 5,763,552;
a fluorinated surfactant of the general formula R″_{f}—(CH₂)ₙ₆COOM′ (4), where R″_{f} represents a perfluoroalkyl group or a perfluoroalkoxy group of 3 to 18 carbon atoms, preferably, 5 to 18 carbon atoms, n6 is from 0 to 2 and M′ is a monovalent cation. In case n6 is 0, R″_{f} represents a perfluoroalkyl group of 3 to 18 carbon atoms, preferably, 5 to 18 carbon atoms;
a fluorinated surfactant of general formula R″_{f}—(CH₂)ₙ₇-(OCH₂CH₂)ₘ₇—OH(5), where R″_{f} represents a perfluoroalkyl group or a perfluoroalkoxy group of 3 to 18 carbon atoms, preferably 8 to 18 carbon atoms, n7 is from 0 to 2, preferably 1, or 2 and m7 is from 0 to 5, preferably from 0 to 3; in case n7 is 0, R″_{f} represents a perfluoroalkyl group of 3 to 18 carbon atoms, preferably 5 to 18 carbon atoms;
perfluoropolyethers of formula F—(CF₂)ₘ₈—O—[CFX³—CF₂—O]ₙ₈—CFX³-COOA¹ (6), wherein m8 is 1 to 5, X³ is F or CF₃, A1 is a monovalent cation and n8 is 0 to 10, described in U.S. Pat. No. 3,271,341;
fluorinated polyethers of the formula F—(CF₂)ₘ₈—O—[CFX—CF₂—O]ₙ₈—CFX-COOA³ (7), wherein m8′ is 3 to 10, X³ is F or a perfluoroalkyl group, n8′ is 0.1 or 2 and A3 is the counter ion of the carboxylic anion, described in US2005/0090613;
fluorinated polyether surfactants of formula R_{f2}—O—CF₂CF₂—X⁴ (8), wherein R_{f2} represents a linear or branched perfluoroalkyl group having 1, 2, 3 or 4 carbon atoms and X⁴ represents a carboxylic acid group or salt thereof, described in WO05/03075. Examples of carboxylic acid salts include sodium, potassium and ammonium (NH₄) salts. Perfluoro ether surfactants, in which R_{f2} represents a perfluoroalkyl group selected from CF₃, CF₃CF₂, CF₃CF₂CF₂, (CF₃)₂CF and (CF₃)₃C are preferred;
a fluorinated polyether surfactant of formula H(OCH₂CH₂) K—OCH₂CF₂—(OCF₂)—(OCF₂CF₂)ₘ₉—OCF₂CH₂—(OCH₂CH₂)ₙ₉OH (9), wherein k is 0.1 or 2,1 is 2 to 150, especially 2 to 10, m9 is 1 to 100, especially 5 to 20, n9 is 0.1 or 2, such as, for example, Fluorolink® E10H(Solvay) or Fluorolink® PEG45;
fluorinated polyether surfactants, containing pendant (meth)acrylic groups, such as, for example, perfluoropolyether urethane acrylate Fluorolink® AD1700 and perfluoropolyether urethane methacrylate Fluorolink® MD700;
fluorinated polyether surfactants of general formula (OH)₂ (O) P—[(OCH₂CH₂)ₚ—OCH₂—R_{f3}—CH₂O—(CH₂CH₂O)ₚP(O)OH]_{q}OH (10), wherein p=1-2, q=1-4 and Reis CH₂O—(CF₂) m10-(CF₂—CF₂—O)ₙ₁₀—CF₂, wherein m10 is 1 to 100, especially 5 to 20, n10 is 0.1 or 2, such as for example, Fluorolink® P54 (Solvay);
perfluoropolyether compounds derivatives of the formula (OH)₃₋ₙ₁₁—(R¹¹O)ₙ₁₁Si—R¹—NH—C(O)—CF₂O—(CF₂CF₂O)ₚ—(CF₂O) q-CF₂—C(O)—NH—R¹—Si(OR″)ₙ₁₁(OH)₃₋ₙ₁₁ (11), wherein R¹ is alkylene from 1 to 10 carbon atoms, preferably from 1 to 5 carbon atoms, still more preferably from 2 to 4 carbon atoms; R¹¹ is a linear or branched alkyl group from 1 to 4 carbon atoms, preferably from 1 to 3 carbon atoms; n11 is an integer from 0 to 3, preferably 3; p and q are numbers such that the q/p ratio is between 0.2 and 4; and p is different from zero;
perfluoropolyether compounds functionalized with silane groups of the formula (EtO)₃—Si—R¹—NH—C(O)—CF₂O—(CF₂CF₂O)ₚ—(CF₂O) q-CF₂—C(O)—NH—R¹—Si(OEt)₃ (12), wherein R¹ is alkylene from 1 to 10 carbon atoms, preferably from 1 to 5 carbon atoms, still more preferably from 2 to 4 carbon atoms and p and q are numbers such that the q/p ratio is between 0.2 and 4; and p is different from zero, such as, for example, Fluorolink® S10 (Solvay) with the formula

(EtO)₃—Si—CH₂CH₂CH₂—NH—C(O)—CF₂O—(CF₂CF₂O)ₚ—(CF₂O) q-CF₂—C(O)—NH—CH₂CH₂CH₂—Si(OEt)₃ (13), wherein p=2-6 and q=2-4. Compounds of formulae (1) to (9) and fluorinated polyether surfactants, containing pendant (meth)acrylic groups are preferred. More preferred are compounds of formulae (1), (3), (4), (6), (8) and (9). Especially preferred are compounds of formulae (4) and (9).

The coatings, obtained with said compositions, show one color, when observed in transmission and another color, when observed in reflection on both sides of the cured coating. The metal-like reflection of coatings, obtained with the compositions of the present invention, may be further enhanced by the presence of the above described fluoro-surfactants, especially the compounds of formulae (1), (3), (4), (6), (8) and (9), very especially the compounds of formulae (4) and (9).

Further surfactants, which may be used, include, non-fluorinated anionic surfactants, cationic surfactants, nonionic surfactants, amphoteric or zwitterionic surfactants. Anionic surfactants include, for example, alkyl sulfates (eg., dodecylsulfate), alkylamide sulfates, fatty alcohol sulfates, secondary alkyl sulfates, paraffin sulfonates, alkyl ether sulfates, alkylpolyglycol ether sulfates, fatty alcohol ether sulfates, alkylbenzenesulfonates, alkylphenol ether sulfates, alkyl phosphates; alkyl or alkylaryl monoesters, diesters, and triesters of phosphoric acid; alkyl ether phosphates, alkoxylated fatty alcohol esters of phosphoric acid, alkylpolyglycol ether phosphates (for example, polyoxyethylene octadecenyl ether phosphates marketed as LUBRHOPHOS® LB-400 by Rhodia), phosphonic esters, sulfosuccinic diesters, sulfosuccinic monoesters, alkoxylated sulfosuccinic monoesters, sulfosuccinimides, α-olefinsulfonates, alkyl carboxylates, alkyl ether carboxylates, alkyl-polyglycol carboxylates, fatty acid isethionate, fatty acid methyltauride, fatty acid sarcoside, alkyl sulfonates (eg., 2-(methyloleoylamino) ethane-1-sulfonate, marketed as GEROPON® T77 by Solvay)alkyl ester sulfonates, arylsulfonates (eg., diphenyl oxide sulfonate, marketed as RHODACAL® DSB by Rhodia), naphthalenesulfonates, alkyl glyceryl ether sulfonates, polyacrylates, a-sulfo-fatty acid esters, and salts and mixtures thereof.

Cationic surfactants include, for example, aliphatic, cycloaliphatic or aromatic primary, secondary and tertiary ammonium salts or alkanolammonium salts; quaternary ammonium salts, such as tetraoctylammonium halides and cetyltrimethylammonium halides (eg., cetyltrimethylammonium bromide (CTAB)); pyridinium salts, oxazolium salts, thiazolium salts, salts of amine oxides, sulfonium salts, quinolinium salts, isoquinolinium salts, tropylium salts.

Other cationic surfactants suitable for use according to the present disclosure include cationic ethoxylated fatty amines. Examples of cationic ethoxylated fatty amines include, but are not limited to, ethoxylated oleyl amine (marketed as RHODAMEEN® PN-430 by Solvay), hydrogenated tallow amine ethoxylate, and tallow amine ethoxylate. Nonionic surfactants include, for example, alcohol alkoxylates (for example, ethoxylated propoxylated C₈-C₁₀ alcohols marketed as ANTAROX® BL-225 and ethoxylated propoxylated C₁₀-C₁₆ alcohols marketed as ANTAROX® R_{A}-40 by Rhodia), fatty alcohol polyglycol ethers, fatty acid alkoxylates, fatty acid polyglycol esters, glyceride monoalkoxylates, alkanolamides, fatty acid alkylolamides, alkoxylated alkanol-amides, fatty acid alkylolamido alkoxylates, imidazolines, ethylene oxide-propylene oxide block copolymers (for example, EO/PO block copolymer marketed as ANTAROX® L-64 by Rhodia), block copolymers of ethylene and ethylene oxide, alkylphenol alkoxylates (for example, ethoxylated nonylphenol marketed as IGEPAL® CO-630 and ethoxylated dinonylphenol/nonylphenol marketed as IGEPAL® DM-530 by Rhodia), alkyl glucosides, alkoxylated sorbitan esters (for example, ethoxylated sobitan monooleate marketed as ALKAMULS® PSMO by Rhodia), alkyl thio alkoxylates (for example, alkyl thio ethoxylates marketed as ALCODET® by Rhodia), amine alkoxylates, and mixtures thereof. Typically, nonionic surfactants include addition products of ethylene oxide, propylene oxide, styrene oxide, and/or butylene oxide onto compounds having an acidic hydrogen atom, such as, for example, fatty alcohols, alkylphenols or alcohols. Examples are addition products of ethylene oxide and/or propylene oxide onto linear or branched fatty alcohols having from 1 to 35 carbon atoms, onto fatty acids having from 6 to 30 carbon atoms and onto alkylphenols having from 4 to 35 carbon atoms in the alkyl group; (C₆-C₃₀)-fatty acid monoesters and diesters of addition products of ethylene oxide and/or propylene oxide onto glycerol; glycerol monoesters and diesters and sorbitan monoesters, diesters and triesters of saturated and unsaturated fatty acids having from 6 to 22 carbon atoms and their ethylene oxide and/or propylene oxide addition products, and the corresponding polyglycerol-based compounds; and alkyl monoglycosides and oligoglycosides having from 8 to 22 carbon atoms in the alkyl radical and their ethoxylated or propoxylated analogues. Amphoteric or zwitterionic surfactants include, but are not limited to, aliphatic quaternary ammonium, phosphonium, and sulfonium compounds, wherein the aliphatic radicals can be straight chain or branched, and wherein the aliphatic substituents contain about 6 to about carbon atoms and at least one aliphatic substituent contains an anionic functional group, such as carboxy, sulfonate, sulfate, phosphate, phosphonate, and salts and mixtures thereof. Examples of zwitterionic surfactants include, but are not limited to, alkyl betaines, alkyl amidopropyl betaines, alkyl sulphobetaines, alkyl glycinates, alkyl carboxyglycinates; alkyl amphopropionates, such as cocoamphopropionate and caprylamphodipropionate (marketed as MIRANOL® JBS by Rhodia); alkyl amidopropyl hydroxysultaines, acyl taurates, and acyl glutamates, wherein the alkyl and acyl groups have from 6 to 18 carbon atoms, and salts and mixtures thereof.

In a particularly preferred embodiment the surfactant (E) is a block copolymer described in EP21173520.4, which comprises at least a block A and a block B, wherein
a) the block A comprises
a1) monomer units (A1) derived from a compound selected from alkyl (meth)acrylates, alkyl (meth)acrylamides, or any mixture thereof, and
a2) monomer units (A2) derived from a hydroxy group, or ether group containing alkyl (meth)acrylate;
b) the block B comprises monomer units (B) derived from a compound selected from a fluorinated (meth)acrylic esters of formula

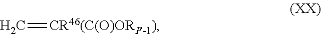

wherein
R⁴⁶ is H, or a methyl group; and
R_{F-1} is an organic residue containing a perfluorinated alkyl group.

Preferably, block A comprises monomer units (A1) derived from a compound selected from C₁-C₁₈alkyl (meth)acrylates, more preferably C₁-C₁₀alkyl (meth)acrylates (H₂C═CR⁴⁷(C(O)OR⁴⁹; wherein R⁴⁷ is H, or a methyl group; and R⁴⁹ is a C₁-C₁₈alkyl group, especially a C₁-C₁₀alkyl group), such as, for example, ethyl(meth)acrylate, n-propyl(meth)acrylate, n-butyl(meth)acrylate, isobutyl(meth)acrylate, t-butyl(meth)acrylate, 2-ethylhexyl (meth)acrylate and isodecyl(meth)acrylate, especially n-propylacrylate, n-butylacrylate, isobutylacrylate and 2-ethylhexylacrylate.

In addition, block A comprises monomer units (A2) derived from a compound selected from a hydroxy group, or ether group containing alkyl (meth)acrylate of formula

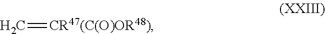

wherein
R⁴⁷ is H, or a methyl group; and
R⁴⁸ is a hydroxyC₁-C₈alkyl group, especially a hydroxyC₁-C₄alkyl group, or a C₁-C₃alkoxyC₁-C₅alkyl group.

Preferably, block A comprises monomer units (A2) derived from a compound selected from a hydroxy group, or ether group containing alkyl (meth)acrylate of formula
H₂C═CR⁴⁷ (C(O)OR⁴⁸) (XXIII), wherein R⁴⁷ is H; and
R⁴⁸ is a hydroxyC₁-C₄alkyl group, such as, for example, 2-hydroxyethyl(meth)acrylate, hydroxy-n-propyl (meth)acrylate and hydroxy-n-butyl (meth)acrylate.

Preferably, the block A consists of monomer units derived from a compound selected from monomer units (A1) derived from a compound selected from C₁-C₁₀alkyl (meth)acrylates and monomer units (A2) derived from a compound selected from a hydroxy group, or ether group containing alkyl (meth)acrylate of formula H₂C═CR⁴⁷ (C(O)OR⁴⁸) (XXIII), wherein R⁴⁷ is H; and R⁴⁸ is a hydroxyC₁-C₄alkyl group.

The block copolymer contains one or more blocks of type “A”, which may differ in block length (i.e. different number of monomer units).

In a preferred embodiment, the block A of the block copolymer has an average number of monomer units (A1) and (A2) of from 5 to 1000, more preferably from 10 to 500, even more preferably from 15 to 300, most preferred 20 to 100.

Preferably, R_{F-1} is a group of formula —(X³)ₓ—(CF₂) x1—CF₃ (XXII), wherein x is 0 or 1; x1 is an integer of 2 to 17, especially 3 to 11, very especially 3 to 7; and X³ is a divalent non-fluorinated C₁₄alkylene group, which can be substituted or unsubstituted.

Accordingly, the fluorinated (meth)acrylic ester of formula (XX) is preferably a fluorinated (meth)acrylic ester of formula H₂C═CR⁴⁶ (C(O)O(X¹)ₓ—(CF₂)×1—CF₃) (XXa), wherein x is 0 or 1; x1 is an integer of 2 to 17, especially 3 to 11, very especially 3 to 7; and X³ is a divalent non-fluorinated C₁₄alkylene group, which can be substituted or unsubstituted; and R⁴⁶ is H, or a methyl group.

In a preferred embodiment, x is 1 and X³ is —(CH₂) 14-; such as, for example, —CH₂—, —CH₂—CH₂—; —CH₂—CH₂—CH₂—; or —CH₂—CH₂—CH₂—CH₂—.

In a preferred embodiment, the fluorinated (meth)acrylic ester compound of formula (XXa) is selected from H₂C═CR⁴⁶ (C(O)O(CH₂) z (CF₂)₃—CF₃, H₂C═CR⁴⁶ (C(O)O(CH₂)₂—(CF₂) 4—CF₃, H₂C═CR⁴⁶ (C(O)O(CH₂)₂—(CF₂) 5—CF₃, H₂C═CR⁴⁶ (C(O)O(CH₂)₂—(CF₂) 6—CF₃ and H₂C═CR⁴⁶ (C(O)O(CH₂)₂—(CF₂) 7—CF₃, wherein R⁴⁶ is H, or a methyl group; and mixtures thereof.

Alternatively, the block B may contain two, or more different monomer units.

If the block copolymer contains two or more blocks of type “B”, they may differ in block length (i.e. different number of monomer units).

Preferably, the block B of the block copolymer has an average number of monomer units which are derived from the fluorinated (meth)acrylic ester of formula (XX) of at least 0.25, more preferably at least 0.5, or at least 1.

In a preferred embodiment, the block B of the block copolymer has an average number of monomer units which are derived from the fluorinated (meth)acrylic ester of formula (XX) of from 0.25 to 40, more preferably 0.5 to 30, even more preferably 1 to 20.

Preferably, the block B of the block copolymer has an average number of monomer units which are derived from the fluorinated acrylic ester of formula (XX) of from 0.25 to 40, more preferably 0.5 to 30, even more preferably 1 to 20.

Preferably, the block copolymer has a number average molecular weight Mₙ of from 1000 to 100,000 g/mol, more preferably from 2,000 to 50,000 g/mol, even more preferably 3,000 to 25,000 g/mol.

Preferably, the block copolymer comprises the monomer units derived from the fluorinated (meth)acrylic ester of formula (XX) in an amount of from 0.1 wt % to 70 wt %, more preferably from 0.5 wt % to 50 wt %, even more preferably from 1 wt % to 35 wt %.

Preferably, the block copolymer has a fluorine content of from 0.05 wt % to 35 wt %, more preferably from 0.25 wt % to 33 wt %, even more preferably from 0.5 wt % to 31 wt %.

Preferably, the block copolymer has a polydispersity index PDI (i.e. Mw/Mn) of less than 1.90, more preferably of less than 1.60, even more preferably of less than 1.40, or even less than 1.30.

The block copolymer is preferably obtained by a controlled free radical polymerization (sometimes also referred to as “controlled radical polymerization”). Methods of “controlled free radical polymerization” are generally known to the skilled person.

In a preferred embodiment, the controlled free radical polymerization is selected from nitroxide-mediated controlled polymerization (NMP), atom transfer radical polymerization (ATRP), or from reversible addition-fragmentation chain transfer polymerization (RAFT).

These polymerization methods and variants thereof are generally known to the skilled person. The reversible addition-fragmentation chain transfer polymerisation RAFT using chain transfer agents which react by reversible addition-fragmentation chain transfer is described, for example, in WO98/01478, WO99/05099, WO99/31144 and WO2009/103613. RAFT describes a method of polymer synthesis by radical polymerization in the presence of a free radical source and using chain transfer agents which react by reversible addition-fragmentation chain transfer. The chain transfer agent is, for example, 2-phenylprop-2-yl dithiobenzoate (Ph-C(CH₃,CH₃)—S—C(S)-Ph), or benzyldithioacetate (Ph-CH₂—S—C(S)—CH₃) as described in WO98/01478, carbamates such as benzyl 1-pyrrolecarbodithioate, as described in WO99/31144; alkylxanthates, such as ethyl a (O-ethylxanthyl propionate), as described in WO 98/58974.

WO96/30421 discloses a controlled polymerisation process of ethylenically unsaturated polymers, such as styrene or (meth)acrylates, by employing the Atomic Transfer Radical Polymerisation (ATRP) method. This method produces defined oligomeric homopolymers and copolymers, including block copolymers. Initiators are employed, which generate radical atoms, such as ·Cl, in the presence of a redox system of transition metals of different oxidation states, e.g. Cu(I) and Cu(II), providing “living” or controlled radical polymerisation.

Details about nitroxide-mediated controlled polymerization are described e.g. in WO2005/059048 and WO2009/103613. The initiator compounds described therein can be used in the present invention as well. More preferably, the controlled radical polymerization is selected from nitroxide mediated controlled polymerization (NMP) and atom transfer radical polymerization (ATRP), even more preferably from NMP.

In a preferred embodiment, the controlled radical polymerization is a nitroxide mediated controlled polymerization, which preferably uses a polymerization regulator system based on polymerization regulator compounds being preferably selected from nitroxylether having the structural element

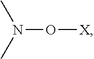

wherein X represents a group having at least one carbon atom and is such that the free radical X· derived from X is capable of initiating polymerization.

The nitroxylether is preferably a compound of formula

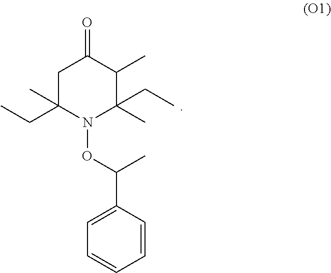 [SMILES: CCC1(C)CC(=O)C(C)C(C)(CC)N1OC(C)c1ccccc1]

The block copolymer can be obtained by a process comprising the steps
i) polymerizing in a first step a first monomer (A1) and a second monomer (A2); in the presence of at least one nitroxylether having the structural element

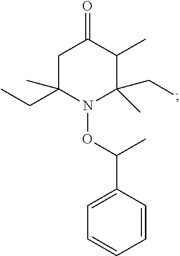

and
ii) a second step, comprising the modification of the polymer or copolymer prepared under i) by chain extension with monomer (B) and residual monomer treatment.

Block copolymers represented by formula

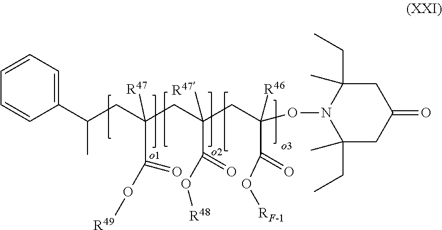

are preferred, wherein o1 is 30 to 100; 02 is 10 to 40 and o3 is 1 to 15, especially 1 to 10;
R_{F-1} is a group (X³)ₓ—(CF₂)ₓ₁—CF₃, wherein x is 1, x1 is an integer 1 to 7 and X³ is —(CH₂) 14-;
R⁴⁶ is H, or a methyl group, especially H; R⁴⁷ is H, or a methyl group, especially H; R⁴⁷ is H, or a methyl group, especially H;
R⁴⁸ is a hydroxyC₁-C₄alkyl group;
R⁴⁹ is a C₁-C₁₀alkyl group; and
block copolymers of formula

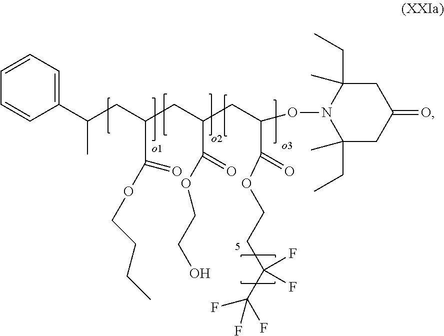

wherein o1 is 70 to 80; o2 is 25 to 30 and o3 is 1 to 10, are even more preferred. Most preferred o is o3 is 3 to 10.

### F) Polymeric Binder

The printing (or coating) composition may comprise a polymeric binder.

The polymeric binder is a high-molecular-weight organic compound conventionally used in coating compositions. High molecular weight organic materials usually have molecular weights of about from 103 to 108 g/mol or even more. They may be, for example, natural resins, drying oils, rubber or casein, or natural substances derived therefrom, such as chlorinated rubber, oil-modified alkyd resins, viscose, cellulose ethers or esters, such as ethylcellulose, cellulose acetate, cellulose propionate, cellulose acetobutyrate or nitrocellulose, but especially totally synthetic organic polymers (thermosetting plastics and thermoplastics), as are obtained by polymerisation, polycondensation or polyaddition. From the class of the polymerisation resins there may be mentioned, especially, polyolefins, such as polyethylene, polypropylene or polyisobutylene, and also substituted polyolefins, such as polymerisation products of vinyl chloride, vinyl acetate, styrene, acrylonitrile, acrylic acid esters, methacrylic acid esters or butadiene, and also copolymerisation products of the said monomers, such as especially ABS or EVA.

With respect to the polymeric binder, a thermoplastic resin may be used, examples of which include, polyethylene based polymers [polyethylene (PE), ethylene-vinyl acetate copolymer (EVA), vinyl chloride-vinyl acetate copolymer, vinyl alcohol-vinyl acetate copolymer, polypropylene (PP), vinyl based polymers [poly(vinyl chloride) (PVC), poly(vinyl butyral) (PVB), poly(vinyl alcohol) (PVA), poly(vinylidene chloride) (PVdC), poly(vinyl acetate) (PVAc), poly(vinyl formal) (PVF)], polystyrene based polymers [polystyrene (PS), styrene-acrylonitrile copolymer (AS), acrylonitrile-butadiene-styrene copolymer (ABS)], acrylic based polymers [poly(methyl methacrylate) (PMMA), MMA-styrene copolymer], polycarbonate (PC), celluloses [ethyl cellulose (EC), cellulose acetate (CA), propyl cellulose (CP), cellulose acetate butyrate (CAB), cellulose nitrate (CN), also known as nitrocellulose], urethane based polymers (PU), polyesters (alkyl) [polyethylene terephthalate (PET), polybutylene terephthalate (PBT), polycyclohexane terephthalate (PCT)], novolac type phenolic resins, or the like. In addition, thermosetting resins such as resol type phenolic resin, a urea resin, a melamine resin, a polyurethane resin, an epoxy resin, an unsaturated polyester and the like, and natural resins such as protein, gum, shellac, copal, starch and rosin may also be used.

The polymeric binder preferably comprises nitrocellulose, ethyl cellulose, cellulose acetate, cellulose acetate propionate (CAP), cellulose acetate butyrate (CAB), alcohol soluble propionate (ASP), vinyl chloride copolymers, vinyl acetate homo- or copolymers, vinyl ester homo- or copolymers, vinyl ether homo- or copolymers, poly(vinyl butyral) (PVB), acrylic polymers, polyurethane, polyamide, rosin ester resins, aldehyde or ketone resins, polyurethane, polyethyleneterephthalate, terpene phenol resins, olefin copolymers, silicone copolymers, cellulose, polyamide, polyester and rosin ester resins, shellac and mixtures thereof.

Most preferred, the polymeric binder is selected from the group consisting of nitro cellulose, vinyl chloride copolymers, vinyl ester, especially, vinyl acetate copolymers, poly(vinyl butyral) (PVB), vinyl, acrylic, urethane, polythyleneterephthalate, terpene phenol, polyolefin, cellulose, polyamide, polyester and rosin ester resins or mixtures thereof.

Preferably, polymeric binder is at least partially soluble in the composition.

### G) Solvent

In the context of the composition of the present invention the term “solvent” means a compound with boiling point of below 250° C., preferably, below 200° C., which substantially evaporates during and/or after coating or printing of the compositions according to the present invention prior to the radiation curing step.

The solvent is preferably selected from alcohols (such as ethanol, 1-propanol, 2-propanol, 1-butanol, 2-butanol, isobutanol, tert-butanol, tert-pentanol), cyclic or acyclic ethers (such as diethyl ether, tetrahydrofuran and 2-methyltetrahydrofurane), cyclic or acyclic ketones (such as acetone, 2-butanone, 3-pentanone, cyclopentanone), ether-alcohols (such as 2-methoxyethanol, 1-methoxy-2-propanol, ethylene glycol monobutyl ether, diethylene glycol monoethyl ether, diethylene glycol monopropyl ether, 1-methoxy-2-propylacetate and diethylene glycol monobutyl ether), esters (such as ethyl acetate, ethyl propionate, 1-methoxy-2-propylacetate and ethyl 3-ethoxypropionate), mixtures thereof and mixtures with water. The preferred solvents include C₂-C₆alcohols, ketones, esters, ether-alcohols and mixtures thereof.

The amount of solvent, such as, for example, 1-methoxy-2-propanol, 1-methoxy-2-propylacetate, methyl ethyl ketone, ethyl acetate, or ethyl 3-ethoxypropionate, is preferably in the range of from 40 to 90% by weight, more preferably 50 to 85% by weight, most preferred 60 to 85% by weight based on the whole amount of the composition.

### H) Further Additives

The printing (or coating) composition may comprise various additives (I). Examples thereof include thermal inhibitors, coinitiators and/or sensitizers, light stabilisers, optical brighteners, fillers and pigments, as well as white and coloured pigments, dyes, antistatics, wetting agents, flow auxiliaries, lubricants, waxes, anti-adhesive agents, dispersants, emulsifiers, adhesion promoters, anti-oxidants; fillers, e.g. talcum, gypsum, silicic acid, rutile, carbon black, zinc oxide, iron oxides; reaction accelerators, thickeners, matting agents, antifoams, leveling agents and other adjuvants customary, for example, in lacquer, ink and coating technology.

Examples of coinitiators/sensitisers are especially aromatic carbonyl compounds, for example benzophenone, thioxanthone, especially isopropyl thioxanthone, anthraquinone and 3-acylcoumarin derivatives, terphenyls, styryl ketones, and also 3-(aroylmethylene)-thiazolines, camphor quinone, and also eosine, rhodamine and erythrosine dyes. Amines, for example, can also be regarded as photosensitisers when the photoinitiator consists of a benzophenone or benzophenone derivative.

### Examples of Light Stabilizers are

Phosphites and phosphonites (processing stabilizer), for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,4-di-cumylphenyl) pentaerythritol diphosphite, bis(2,6-di-tert-butyl-4-methylphenyl) pentaerythritol diphosphite, diisodecyloxypentaerythritol diphosphite, bis(2,4-di-tert-butyl-6-methylphenyl) pentaerythritol diphosphite, bis(2,4,6-tris(tert-butylphenyl) pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz [d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz [d,g]-1,3,2-dioxaphosphocin, 2,2′,2″-nitrilo [triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid, 4-(1,1-mixed 2,4-bis(1,1-dimethylpropyl)phenyl and dimethylpropyl)phenyl triesters (CAS No. 939402 Feb. 5), Phosphorous acid, triphenyl ester, polymer with alpha-hydro-omega-hydroxypoly [oxy (methyl-1,2-ethanediyl)], C₁₀⁻¹⁶ alkyl esters (CAS No. 1227937-46-3). The following phosphites are especially preferred: Tris(2,4-di-tert-butylphenyl) phosphite, tris(nonylphenyl) phosphite,

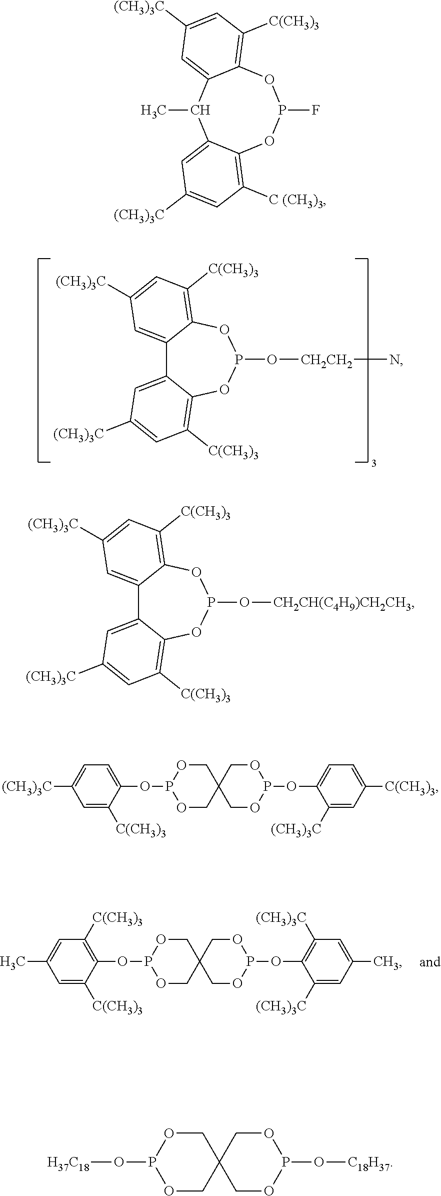

### Quinone Methides of the Formula

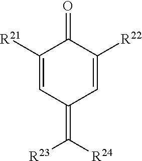

(providing long term shelf life stability), wherein
R²¹ and R²² independently of each other are C₁-C₁₈alkyl, C₅-C₁₂cycloalkyl, C₇-C₁₅-phenylalkyl, optionally substituted C₆-C₁₀aryl;
R²³ and R²⁴ independently of each other are H, optionally substituted C₈-C₁₀-aryl, 2-,3-,4-pyridyl, 2-,3-furyl or thienyl, COOH, COOR²⁵, CONH₂, CONHR²⁵, CONR²⁵R²⁶, —CN, —COR²⁵, —OCOR²⁵, —OPO(OR²⁵)₂, wherein R²⁵ and R²⁸ are independently of each other C₁-C₈alkyl, or phenyl. Quinone methides are preferred, wherein R²¹ and R²² are tert-butyl;
R²³ is H, and R²⁴ is optionally substituted phenyl, COOH, COOR²⁵, CONH₂, CONHR²⁵, CONR²⁵R²⁶, —CN, —COR²⁵, —OCOR²⁵, —OPO(OR²⁵)₂, wherein R²⁵ and R²⁸ are C₁-C₈alkyl, or phenyl. Examples of quinone methides are

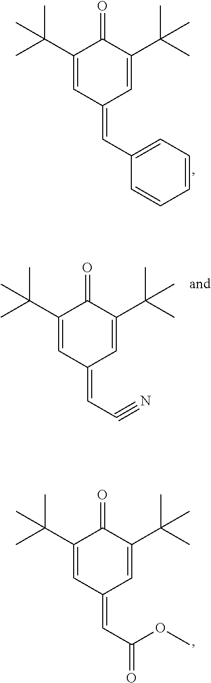

The quinone methides may be used in combination with highly sterically hindered nitroxyl radicals as described, for example, in US20110319535.

The quinone methides are used typically in a proportion of from about 0.01 to 0.3% by weight, preferably from about 0.04 to 0.15% by weight, based on the total weight of the UV curable composition.

Leveling agents used, which additionally also serve to improve scratch resistance, can be the products TEGO® Rad 2100, TEGO® Rad 2200, TEGO® Rad 2300, TEGO® Rad 2500, TEGO® Rad 2600, TEGO® Rad 2700 and TEGO® Twin 4000, likewise obtainable from Tego. Such auxiliaries are obtainable from BYK, for example as BYK®-300, BYK®-306, BYK®-307, BYK®-310, BYK®-320, BYK®-322, BYK®-331, BYK®-333, BYK®-337, BYK®-341, Byk® 354, Byk® 361 N, BYK®-378 and BYK®-388.

Leveling agents are typically used in a proportion of from about 0.005 to 1.0% by weight, preferably from about 0.01 to 0.2% by weight, based on the total weight of the solvent based composition.

Adhesion promoters may be used to improve adhesion of the coating to the substrate and/or to top layer. Examples of such products are TEGO® AddBond LP 1600, TEGO® AddBond LP 1611, TEGO® AddBond LTH (all from Evonik), Nazdar 7020 or Nazdar 7035 UV from Nazdar Ink Technologies. Adhesion promoters are typically used in a proportion of from about 0.005 to 2.0% by weight based on the total weight of the solvent based composition.

Thickeners (also called thickening agent) may be used in the compositions of present invention to optimize the viscosity for a particular application method, such as gravure, flexographic, or ink-jet printing, or slot-die coating.

Examples of such thickeners are inorganic thickeners, examples being metal silicates such as phyllosilicates, and organic thickeners, examples being poly(meth)acrylic acid thickeners and/or (meth)acrylic acid-(meth)acrylate copolymer thickeners, polyurethane thickeners, polyurea thickeners and polymeric waxes. The metal silicate is preferably selected from the group of the smectites. With particular preference the smectites are selected from the group of the montmorillonites and hectorites. More particularly the montmorillonites and hectorites are selected from the group consisting of aluminum magnesium silicates and also sodium magnesium phyllosilicates and sodium magnesium fluorine lithium phyllosilicates. These inorganic phyllosilicates are sold for example under the brand name Laponite®. Thickening agents based on poly(meth)acrylic acid, and (meth)acrylic acid-(meth)acrylate copolymer thickeners are optionally crosslinked and/or neutralized with a suitable base. Examples of such thickening agents are Alkali Swellable Emulsions (ASE), and hydrophobically modified variants thereof, the “Hydrophilically modified Alkali Swellable Emulsions” (HASE). These thickening agents are preferably anionic. Corresponding products such as Rheovis® AS 1130 are available commercially. Thickening agents based on polyurethanes (e.g., polyurethane associative thickening agents) are optionally crosslinked and/or neutralized with a suitable base. Corresponding products such as Rheovis® PU 1250 are available commercially. Thickening agents may be based on polyurea. A polyurea thickener is a reaction product of a diisocyanate with monoamines and/or diamines. This class includes diurea, tetraurea and urea-urethane. The ratios of the ingredients determine the characteristics of the thickener. Corresponding products are available commercially, for example under the tradenames EFKA, or Rheovis UR. Examples of suitable polymeric waxes include optionally modified polymeric waxes based on ethylene-vinyl acetate copolymers. Corresponding products are available commercially, for example, under the Aquatix® designation. The at least one thickener is preferably present in the cimposition of the invention in an amount of at most 10 wt %, more preferably of at most 7.5 wt %, very preferably of at most 5 wt %, more particularly of at most 3 wt %, most preferably of at most 2 wt %, based in each case on the total weight of the composition.

In a preferred embodiment the solvent based composition comprises
A) 1 to 12% by weight, preferably 2 to 10% by weight, more preferably 2 to 8% by weight, most preferred 2.5 to 7% by weight of the silver nanoplatelets (A),
B)₃ to 60% by weight preferably 4 to 50%, more preferably 5 to 40% by weight, most preferred 7 to 30% by weight of the reactive diluent(s) (B),
C) 0 to 40% by weight, preferably 0 to 30% by weight, more preferably 0 to 20% by weight, most preferred 0 to 10% by weight of the oligomer(s) (C),
D) 0.3 to 7% by weight, preferably 0.5 to 5% by weight, more preferably 1 to 4% by weight of the radical photoinitiator(s) (D),
E) 0 to 3% by weight, preferably 0.01 to 2% by weight, more preferably 0.05 to 1.5% by weight, most preferred 0.075 to 1% by weight of a surfactant(s) (E),
F) 0 to 10% by weight, preferably 0 to 7% by weight, more preferably 0 to 5%, most preferred 0 to 3% by weight of a polymeric binder;
G)₃₀ to 95% by weight, preferably 40 to 95% by weight, more preferably, 50 to 90% by weight, most preferred 50 to 85% by weight of one, or more solvents (G); and
H) 0 to 10% by weight, preferably 0 to 7% by weight, more preferably 0 to 5% by weight of further additives (H),
wherein components (A), (B), (C), (D), (E), (F), (G) and (H) add up to 100% by weight.

In another preferred embodiment the present invention is directed to a UV-Vis radiation radically curable ink, comprising:
I) from about 1 to about 12 wt-% of silver nanoplatelets (A),
II) from about 88 to about 99 wt-% of a solvent based ink vehicle comprising
B) from about 3 to about 50 wt-% of one, or more reactive diluents;
C) from about 0 to about 27 wt-% of one, or more oligomers, wherein one oligomer is preferably a urethane (meth)acrylate (C), which is obtainable by reaction of the following components:
   (a) at least one isocyanate having two isocyanate groups,
   (b) at least one polyalkylene oxide polyether having at least 2 hydroxyl groups,
   (c) at least one hydroxy-functional (meth)acrylate having one hydroxyl group and one (meth)acrylate group,
   (d) at least one compound having at least one isocyanate reactive group and at least one acid function,
   (e) at least one basic compound which is present for neutralization or partial neutralization of the acid groups of component (d),
   (f) optionally at least one monoalcohol having one hydroxy function;
D) from about 0.1 to about 5 wt-% one, or more photoinitiators;
E) from 0.075 to 1% by weight of a surfactant(s) (E);
G) from 25 to 90% by weight of one, or more solvents (G); and
H) from 0 to 10% of further additives (H),
the weight percent of (B), (C), (D), (E), (G) and (H) being based on the total weight of the ink vehicle; and the weight percent of I) and II) being based on the total weight of UV-Vis radiation radically curable ink.

In the above embodiments the reactive diluent (B) is selected from divinyladipate, dipropylene glycol diacrylate, tripropylene glycol diacrylate, dipropylene glycol dimethacrylate, tripropylene glycol dimethacrylate, diethylene glycol diacrylate, triethylene glycol diacrylate, diethylene glycol dimethacrylate, triethylene glycol dimethacrylate, butanediol diacrylate, butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, cyclohexanediol diacrylate, cyclohexanediol dimethacrylate, cyclohexanedimethanol diacrylate, cyclohexanedimethanol dimethacrylate, (ethoxylated)neopentyl glycol diacrylate, (propoxylated)neopentyl glycol diacrylate, (ethoxylated)neopentyl glycol dimethacrylate, (propoxylated)neopentyl glycol dimethacrylate, trimethylolpropane triacrylate (TMPTA), trimethylolpropane trimethacrylate (TMPTMA), ethoxylated trimethylolpropane triacrylates, ethoxylated trimethylolpropane trimethacrylates, propoxylated trimethylolpropane triacrylates, propoxylated trimethylolpropane trimethacrylates, ethoxylated glycerol triacrylates, ethoxylated glycerol trimethacrylates, propoxylated glycerol triacrylates, propoxylated glycerol trimethacrylates, bistrimethylolpropane tetraacrylate, bistrimethylolpropane tetramethacrylate, ethoxylated bistrimethylolpropane tetraacrylates, propoxylated bistrimethylolpropane tetraacrylates, pentaerythritol tetraacrylate, pentaerythritol tetramethacrylate, ethoxylated pentaerythritol tetraacrylates, ethoxylated pentaerythritol tetramethacrylates, propoxylated pentaerythritol tetraacrylates, propoxylated pentaerythritol tetramethacrylates, dipentaerythritol hexaacrylate, ethoxylated dipentaerythritol hexaacrylates, propoxylated dipentaerythritol hexaacrylates and mixtures thereof.

The oligomer is preferably a urethane (meth)acrylate (C), which is preferably obtainable by reaction of the following components:
(a) at least one isocyanate having two isocyanate groups,
(b) at least one polyalkylene oxide polyether having at least 2 hydroxyl groups,
(c) at least one hydroxy-functional (meth)acrylate having one hydroxyl group and one (meth)acrylate group,
(d) at least one compound having at least one isocyanate reactive group and at least one acid function,
(e) at least one basic compound which is present for neutralization or partial neutralization of the acid groups of component (d),
(f) optionally at least one monoalcohol having one hydroxy function.

The photonitiator (D) is a compound of the formula (XII), a compound of the formula (XI), or the photoinitiator is a mixture of different compounds of the formula (XII), or the photoinitiator is a mixture of compounds of the formula (XII) and (XI).

The surfactant (E) is preferably a compound of formula (XXI), more preferred a compound of formula (XXIa).

For the polymeric binder (F) and further additives (H) the preferences outlined above, below apply.

The substrate may contain indicia, or other visible features, or, or other functional layers, in or on its surface, and on at least part of the said substrate surface, a coating (b).

The coating (b) shows a distinct color in transmission and an angle dependent color in reflection, such as, for example, a red, or magenta color in transmission and a red/gold metallic color in reflection under face angle, shifting to a gold and green color in reflection under flat incident light and observation angles. The reflection colors are clearly seen when the transparent substrate comprising the 3-layer stack is put over a black carton. The transmission color is nearly angle independent. Depending on the plasmonic particles used, the transmission color can be different, such as, for example, deep blue instead of magenta.

Due to the simple buildup of the security element and its intensive angle-dependent color a high protection against counterfeit is possible, making the element ideally suitable for banknotes, credit cards and the like.

In a preferred embodiment the layer (b2b) has a varying thickness such that at least two regions of the layer (b2b) have different thicknesses, which results in at least two distinct regions having different angle-dependent colors in reflection on the coating side and/or on the substrate side of the security, or decorative element. The varying thickness of the layer (b2b) is caused by embossing the substrate, or by embossing the solvent based composition after evaporation of solvent.

The layer (b2b) may comprise at least in regions thereof a saw tooth structure, a triangular structure, a wave-like pattern, a step-like-structure, checker-board pattern and/or a diffractive relief structure, in particular a hologram structure, a micromirror structure, a microlens structure, or a microcavities structure.

Step-like-structure: The two partial regions are characterized by a different thickness of the layer (b2b), or in other words the spacing of layers (b2a) and (b2b) is different.

Checker-board pattern: The two partial regions are characterized by a different spacing of layers (b2a) and (b2b).

The two partial regions and, if appropriate, further partial regions are advantageously designed in the form of patterns, characters or codings.

For example, the relief structures are in the form of holographic structures in a first sub-region, in the form of small micromirrors in a second sub-region and produce a holographic image in the first sub-region and an achromatic image which appears to be three-dimensionally pre-curved in the second sub-region. These different optical appearances based on the surface geometry of the relief structures are combined in the present invention with perfectly matched different color flop impressions in the two partial regions.

In another preferred embodiment the layers (b2a) and (b2c) comprise each at least two different regions comprising silver particles exhibiting different angle-dependent colors in reflection on the coating side and/or on the substrate side of the security, or decorative element.

In another preferred embodiment the layers (b2a) and (b2c) comprise each at least two different regions comprising different amounts of silver particles which results in at least two distinct regions having different angle-dependent colors in reflection on the coating side and/or on the substrate side of the security, or decorative element.

The substrate (a) may comprise partially de-metallized regions on top of which the three-layer structure (b2) is arranged.

The decorative, or security element may comprise a high refractive index layer between the substrate (a) and the three-layer structure (b2) and/or between the three-layer structure (b2) and the protective coating (c).

As substrate the usual substrates can be used. The substrate may comprise paper, leather, fabric such as silk, cotton, tyvac, filmic material or metal, such as aluminium. The substrate may be in the form of one or more sheets or a web. The substrate may be mould made, woven, non-woven, cast, calendared, blown, extruded and/or biaxially extruded. The substrate may comprise paper, fabric, man made fibres and polymeric compounds. The substrate may comprise any one or more selected from the group comprising paper, papers made from wood pulp or cotton or synthetic wood free fibres and board. The paper/board may be coated, calendared or machine glazed; coated, uncoated, mould made with cotton or denim content, Tyvac, linen, cotton, silk, leather, polythyleneterephthalate, Propafilm® polypropylene, polyvinylchloride, rigid PVC, cellulose, tri-acetate, acetate polystyrene, polyethylene, nylon, acrylic and polyetherimide board. The polyethyleneterephthalate substrate may be Melinex type film (obtainable from DuPont Films Willimington Delaware, such as, for example, product ID Melinex HS-2), or oriented polypropylene.

The substrates being transparent films or non-transparent substrates like opaque plastic, paper including but not limited to banknote, voucher, passport, and any other security or fiduciary documents, self-adhesive stamp and excise seals, card, tobacco, pharmaceutical, computer software packaging and certificates of authentication, aluminium, and the like.

The substrates can be plain such as in metallic (e.g. A1 foil) or plastic foils (e.g. PET foil), but paper is regarded also as a plain substrate in this sense.

Non-plain substrates or structured substrates comprise a structure, which was intentionally created, such as a hologram, or any other structure, created, for example, by embossing.

In a particularly preferred embodiment the method of the present invention may be used to print dichromic, or trichromic patterns. The patterns may have a defined shape, such as, for example, a symbol, a stripe, a geometrical shape, a design, lettering, an alphanumeric character, the representation of an object or parts thereof. Reference is made to WO2020/156858.

The coating (or layer) (b), which shows intensive angle-dependent color, can be used in known decorative, or security elements, which are, for example, described in WO2009/066048A1, WO2013/017865A1, WO2011/064162, WO2014/041121, WO2014/187750, WO15120975A1, WO16091381A1, WO2017092865, WO2017080641, WO2017028950, WO2017008897, WO2016173695 and WO17008905A3.

Accordingly, the present invention relates to
a security, or decorative element (the structure of which is described in more detail in WO2014/041121), comprising a) a substrate, b) a component with refractive index modulation, in particular a volume hologram, which is obtainable by exposing a recording material to actinic radiation and thereon c) a coating (b) on at least a portion of the refractive index modulated layer;
a security element, or decorative element (the structure of which is described in more detail in WO2014/187750), comprising
a) a substrate
b) a coating on at least a portion of the substrate comprising at least one liquid crystal compound, the coating being applied on the reverse side of the substrate if the substrate is transparent or translucent or on the surface side if the substrate is transparent, translucent, reflective or opaque and
c) a further coating (b) on at least a portion of the coating containing the liquid crystal compound or direct on the substrate if the coating containing the liquid crystal compound is placed on the reverse side of the substrate;
a security element, or decorative element (the structure of which is described in more detail in WO2017092865) for protecting documents of value, comprising a transparent carrier substrate, a layer containing a diffractive optical element (DOE) and a coating (b);
a security, or decorative element, comprising a substrate, an UV lacquer layer on at least part of the substrate having on at least part of its surface a nano- or microstructure, such as, for example an OVD, and on at least part of the UV lacquer layer and/or on at least part of the nano- or microstructure layer, a coating (b); or
a security, or decorative element, capable of interference in the visible range of spectrum, comprising a substrate, optionally, carrying on at least part of its surface a nano- or microstructure, and on at least part of the substrate and/or on at least part of the nano- or microstructure, a coating (b).

Methods for producing the security, or decorative elements (or security features) comprise the steps of
(a) printing, preferably by an application process selected from the group consisting of slot-die coating processes and ink printing processes the solvent-based UV-Vis radiation radically curable compositions of the present invention on a substrate, and (b) curing the solvent-based UV-Vis radiation radically curable composition so as to form the security, or decorative elements (or one or more security features).

The application of coating (layer) (b) is preferably done by a slot-die coating process, or an ink printing process.

A protective coating (c) may be applied on top of coating (b). The protective coating (layer) (c) is preferably transparent or translucent. Examples for coatings are known to the skilled person. For example, water borne coatings, UV-cured coatings or laminated coatings may be used.

The protective coating may be a further functional layer.

UV-cured protective coatings are preferably derived from UV curable compositions which are preferably deposited by means of slot die coating process, gravure, offset flexographic, ink jet, offset and screen printing process.

The UV curable composition comprises preferably
(a) 1.0 to 20.0, especially 1.0 to 15.0, very especially 3.0 to 10.0% by weight of photoinitiator,
(b) 99.0 to 80.0, especially 99.0 to 85.0, very especially 97.0 to 90.0% by weight of a binder (unsaturated compound(s) including one or more olefinic double bonds), wherein the amounts of components a) and b) adds up to 100%.

In a preferred embodiment the UV curable composition comprises (b1) an epoxy-acrylate (10 to 60%) and (b2) one or several (monofunctional and multifunctional) acrylates (20 to 90%) and (a) one, or several photoinitiators (1 to 15%), wherein the amounts of components a), b1) and b2) add up to 100%.

The epoxy-acrylate is selected from reaction products of (meth)acrylic acid with aromatic glycidyl ethers, or aliphatic glycidyl ethers. Aromatic glycidyl ethers are, for example, bisphenol A diglycidyl ether, bisphenol F diglycidyl ether, bisphenol B diglycidyl ether, bisphenol S diglycidyl ether, hydroquinone diglycidyl ether, alkylation products of phenol/dicyclopentadiene, e.g., 2,5-bis[(2,3-epoxypropoxy)phenyl]octahydro-4,7-methano-5H-indene (CAS No. [13446-85-0]), tris[4-(2,3-epoxypropoxy)phenyl]methane isomers (CAS No. [66072-39-7]), phenol-based epoxy novolaks (CAS No. [9003-35-4]), and cresol-based epoxy novolaks (CAS No. [37382-79-9]). Examples of aliphatic glycidyl ethers include 1,4-butanediol diglycidyl ether, 1,6-hexanediol diglycidyl ether, trimethylolpropane triglycidyl ether, pentaerythritol tetraglycidyl ether, 1,1,2,2-tetrakis[4-(2,3-epoxypropoxy)phenyl]ethane (CAS No. [27043-37-4]), diglycidyl ether of polypropylene glycol (α,ω-bis(2,3-epoxypropoxy)poly(oxypropylene), CAS No. [16096-30-3]) and of hydrogenated bisphenol A (2,2-bis[4-(2,3-epoxypropoxy)cyclohexyl]propane, CAS No. [13410⁻⁵⁸-7]).

The one or several acrylates are preferably multifunctional monomers which are selected from trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, tripropylene glycol diacrylate (TPGDA), dipropylene glycol diacrylate (DPGDA), pentaerythritol diacrylate, pentaerythritol triacrylate, pentaerythritol tetraacrylate, dipentaerythritol diacrylate, dipentaerythritol triacry-late, dipentaerythritol tetraacrylate, dipentaerythritol pentaacrylate, dipentaerythritol hexa-acrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, triacrylate of singly to vigintuply alkoxylated, more preferably singly to vigintuply ethoxylated trimethylolpropane, singly to vigintuply propoxylated glycerol or singly to vigintuply ethoxylated and/or propoxylated pentaerythritol, such as, for example, ethoxylated trimethylol propane triacrylate (TMEOPTA) and or mixtures thereof.

In another preferred embodiment the UV curable composition comprises:

| | | |
|---|---|---|
| Bisphenol A epoxyacrylate with 25% TPGDA | 1-35% | by weight |
| Dipropylene glycol diacrylate (DPGDA) | 30-45% | by weight |
| Ethoxylated trimethylol propane | 10-50% | by weight |
| triacrylate (TMEOPTA) | | |
| Reactive tertiary amine | 1-15% | by weight |
| Photoinitiator: | 5-10% | by weight |

The amounts of the components—the of UV curable composition add up to 100% by weight.

In another preferred embodiment the UV curable composition comprises:

| | | |
|---|---|---|
| Tripropylene glycol diacrylate (TPGDA) | 1-25% | by weight |
| Dipropylene glycol diacrylate (DPGDA) | 30-45% | by weight |
| Ethoxylated trimethylol propane | 10-50% | by weight |
| triacrylate (TMEOPTA) | | |
| Reactive tertiary amine | 1-15% | by weight |
| Photoinitiator: | 5-9% | by weight |

The amounts of the components—the of UV curable composition add up to 100% by weight.

The photoinitiator is preferably a blend of an alpha-hydroxy ketone, alpha-alkoxyketone or alpha-aminoketone compound of the formula (XI) and a benzophenone compound of the formula (X); or a blend of an alpha-hydroxy ketone, alpha-alkoxyketone or alpha-aminoketone compound of the formula (XI), a benzophenone compound of the formula (X) and an acylphosphine oxide compound of the formula (XII).

The UV curable composition may comprise various additives. Examples thereof include thermal inhibitors, coinitiators and/or sensitizers, light stabilisers, optical brighteners, fillers and pigments, as well as white and coloured pigments, dyes, antistatics, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, leveling agents and other adjuvants customary, for example, in lacquer, ink and coating technology.

Examples of coinitiators/sensitisers are especially aromatic carbonyl compounds, for example benzophenone, thioxanthone, especially isopropyl thioxanthone, anthraquinone and 3-acylcoumarin derivatives, terphenyls, styryl ketones, and also 3-(aroylmethylene)-thiazolines, camphor quinone, and also eosine, rhodamine and erythrosine dyes. Amines, for example, can also be regarded as photosensitisers when the photoinitiator consists of a benzophenone or benzophenone derivative.

The security element of the invention can be affixed to a variety of objects through various attachment mechanisms, such as pressure sensitive adhesives or hot stamping processes, to provide for enhanced security measures such as anticounterfeiting. The security article can be utilized in the form of a label, a tag, a ribbon, a security thread, and the like, for application to a variety of objects such as security documents, monetary currency, credit cards, merchandise, etc.

Accordingly, the present invention is also directed to a product, comprising the security element according to the present invention, and to the use of the security element according to the present invention for the prevention of counterfeit or reproduction, on a document of value, right, identity, a security label or a branded good.

The security element of the present invention may comprise further functional layers, which are selected from black layers, white layers, continuous metallic layers, deposited, for example by thermal evaporation method, layers, comprising discrete metallic nanostructures capable of absorption of light in the visible wavelength range due to surface plasmon resonance, which may be deposited through vapor-phase metallization, for example, on a surface relief nanostructure, or by printing or coating of compositions, comprising metal nanoparticles, layers comprising surface relief nano- and/or microstructures, such as DOEs, micromirrors, microlenses, layers comprising magnetic pigments, cholesteric liquid crystal layers, fluorescent layers, interference layers, such as, for example, an additional Fabry-Perot stack; colored layers, IR-absorbing layers, colored IR-transparent layers, conductive layers, adhesive and release layers.

The functional layers might be fully, or partially printed on the substrate and/or underlying layer.

The security element of the present invention might be provided as a laminate onto a security document, or as a window on the security document, or embedded as a (windowed) thread into the security document. The security element of the present invention may be, for example, laminated with an adhesive foil, released from the substrate and then incorporated in a security document.

The security document of the present is selected from a banknote, a tax stamp, an ID-card, a voucher, an entrance ticket and a label.

A method of detecting the authenticity of the security element according to the present invention may comprise the steps of:
a) measuring an absorbance, reflectance or transmittance spectrum of the security document in the VIS/NIR range of the electromagnetic spectrum; and
b) comparing the spectrum measured under a) and/or information derived therefrom with a corresponding spectrum and/or information of an authentic security element.

The solvent based composition can used in methods for forming an optically variable image (an optically variable device), which are, for example, described in EP2886343A1, EP2886343A1, EP2886356B1, WO11064162, WO2013/186167 and WO14118567A1.

Accordingly, the present invention relates to
a method for forming an optically variable image (an optically variable device) on a substrate comprising the steps of: forming an optically variable image (OVI) on a discrete portion of the substrate; and depositing the solvent based composition on at least a portion of the OVI;
a method for forming a surface relief microstructure, especially an optically variable image (an optically variable device, OVD) on a substrate described in WO2013/186167 comprises the steps of:
A) applying the solvent based composition to at least a portion of the substrate;
B) contacting at least a portion of the curable composition with a surface relief microstructure, especially optically variable image forming means;
C) curing the composition by using at least one UV lamp.

In a preferred embodiment the method of producing the security element of the present invention comprises the steps of
a)providing a substrate having a surface, which surface may contain indicia or other visible features, such as for example polyethylene terephthalate (PET) film, or a biaxially oriented polypropylene (BOPP) film;
b) applying on top of at least part of the said substrate surface the solvent based composition, and
c) optionally applying a protective layer on top of layer (b).

In another preferred embodiment the method of producing the security element of the present invention comprises the steps of
a)providing a substrate, optionally bearing a surface relief nano- or microstructure,
b) applying the solvent based composition to at least a portion of the substrate, and
c) curing the composition with actinic radiation.

Said method may comprise the steps of:
a) providing a substrate, optionally bearing a surface relief nano- or microstructure,
b1) applying the solvent based composition to at least a portion of the substrate;
b2) embossing a nano- or microstructure into the coating obtained in step b1), and
c) curing the composition with actinic radiation.

In another preferred embodiment the method comprises
i) applying a solvent based composition comprising transition metal particles and the vehicle; on at least part of the surface of the substrate,
ii) drying the solvent based composition;
ii1) embossing a nano- or microstructure into the coating obtained in step ii) and
iii) curing the solvent based composition so as to form the three-layer structure which exhibits intensive angle-dependent colors in reflection on the coating side and/or on the substrate side of the decorative, or security element and a distinctive color in transmission; and
iii) optionally applying a protective coating, or another functional layer on the coating (b).

In step i) the solvent based composition is preferably applied onto the substrate by slot-die coating, or by ink jet printing and the thickness of the three-layer structure is controlled in such a way that different angle-dependent colors in reflection on the coating side and/or on the substrate side in different regions of the security, or decorative element are obtained in one printing step with one same ink after solvent evaporation.

Regarding the method for preparing a coating (b) (as defined above), the skilled person based on its knowledge adjusts the components of the solvent based composition and all process parameters in a suitable manner, in order to optimize the optical properties of the coating (b), taking into account the technical features of the selected substrate and the available technique for applying the solvent based composition to the surface of the substrate. If necessary, suitable solvent based compositions and/or process parameters can be easily identified by test procedures known to the person skilled in the art, which do not require undue experimentation.

Influencing parameters on the droplet formation in piezo technology are the speed of sound in the ink itself, the interfacial tensions between the materials involved and the viscosity of the ink. Furthermore, through the control voltage (waveform) applied to the piezo crystal over time, it is possible to influence the droplet size, speed and shape, and hence the print quality. The aim is a spherical droplet shape without satellite droplets. The droplet size and droplet speed, together with the relative movement of the print head with respect to the substrate, determine the resolution, edge sharpness and print speed of the printing system.

In a preferred embodiment substrates, including paper, are pre-coated with a UV-curable varnish.

The PET film, or the BOPP film may be subjected to a corona treatment before application of the solvent based composition to increase the polarity of its surface.

The three-layer structure (b2) may be applied to partially de-metallized regions of the substrate (a).

The thickness of the layer obtained in step b) is preferably in the range of 200 to 600 nm, preferably 250 to 450 nm.

The coating (b) may be used in the production of security elements, comprising prisms (US2014232100, WO18045429), lenses (US2014247499), and/or micromirrors (US2016170219).

The compositions, comprising silver nanoplatelets, which bear on their surface surface stabilizing agents and stabilizing agents may show surface enhanced Raman scattering (SERS).

Various aspects and features of the present invention will be further discussed in terms of the examples. The following examples are intended to illustrate various aspects and features of the present invention.

### EXAMPLES

### Transmission Electron Microscopy (TEM)

The morphology of the silver particles is characterized by TEM. The number mean diameter (maximal Feret diameter) and the number mean thickness (from cross-sections) are determined from the recorded TEM images.

### Sample Preparation-Number Mean Diameter

After the sample containing the silver particles in isopropanol has been shaken thoroughly ˜200 μl are pipetted into a test tube. The sample is diluted with ethanol until a transparent colored solution is obtained.

### Sample Preparation-Number Mean Thickness

A part of the diluted sample solution is transferred to a smooth foil. After drying the sample is embedded in Araldit®, which is cross-linked below 60° C. Ultrathin cross-sections of the embedded sample are prepared perpendicular to the foil surface.

### Method

Transmission Electron Microscope (TEM), EM910 from Zeiss, INST.109. Image analysis software: ParticleSizer (Thorsten Wagner (2016) ij-particlesizer: ParticleSizer 1.0.9. Zenodo; 10.5281/zenodo.820296) and ImageJ version 1.53f51.

### Results of TEM and Image Analysis

TEM analysis was performed using an EM 910 instrument from ZEISS, INST.109, in bright field mode at an e-beam acceleration voltage of 100 kV. At least 2 representative images with scale in different magnification (5.000x, 10.000X and 20.000×) were recorded in order to characterize the dominant particle morphology for each sample.

The particle size distributions (PSD) are determined with images recorded at magnification 20.000X for the number mean diameter and with magnification 25.000X of the cross-section to determine the number mean thickness.

The images are analyzed by a digital image analysis software (ParticleSizer).

The maximum Feret diameter of more than 500 particles is determined by the image analysis software to obtain the number mean diameter.

In addition, the thickness of more than 300 particle is determined from the cross-sectional TEM images (recorded at magnification 25.000×) by fitting ellipses to the cross-sectioned particles by the software (ParticleSizer). The minor axis (the shortest diameter) of the fitted ellipse is taken as particle thickness.

### Application Example 1

Substrate preparation: Melinex 506 PET foil substrate was coated with a UV-curable varnish Lumogen OVD 311 (commercially available from BASF SE), using K bar wired handcoater #1 and the obtained coating was cured with a medium pressure Hg lamp (total UV dose ca. 500 mJ/cm²) under ambient conditions.

Coating composition (I): Dispersion, obtained in Step c) of Example 1 of WO2020/083794 (0.33 g) was mixed with Laromer LR 8863 (0.84 g), Omnirad 127 (0.07 g), 1-methoxy-2-propanol (2.44 g) and polymer solution, obtained in Step b) of Synthesis Example 2 of European patent application no. 21173520.4 (0.01 g).

| Coating composition (I) | [g] | [%] |
|---|---|---|
| Dispersion of Ag nanoplatelets (40% solids)¹⁾ | 0.33 | 8.95 |
| Laromer LR 8863²⁾ | 0.84 | 22.8 |
| Omnirad 127³⁾ | 0.07 | 1.9 |
| 1-methoxy-2-propanol⁴⁾ | 2.44 | 66.1 |
| Fluorinated block copolymer solution⁵⁾ | 0.01 | 0.27 |
| Sum | 3.69 | 100 |

¹⁾Obtained in Step c) of Example 1 of WO2020/083794
²⁾Commercially available from BASF SE
³⁾Commercially available from IGM Resins
⁴⁾Commercially available from Sigma-Aldrich
⁵⁾Fluorinated block copolymer E-1 in a mixture of 1-methoxy-2-propylacetate and 1-methoxy-2-propanol, obtained in Step b) of Synthesis Example 2 of European patent application no. 21173520.4

The mixture was stirred at room temperature under ambient atmosphere for 1 h to allow for dissolution of Omnirad 127. Thus obtained coating composition was coated on the above described substrate, using K bar wired handcoater #1 and the obtained coating was cured with a medium pressure Hg lamp (total UV dose ca. 600 mJ/cm²).

The coating had a magenta color in transmission and in reflection a red-gold (0° from normal) to green (>50° from normal) color flop was observed from the coating side over a black background.

### Application Examples 2 to 6

### Coating Composition (II) for Slot-Die Coating:

The following composition was prepared starting from the dispersion obtained in Step c) of Example 1 of WO2020/083794:

| Coating composition (II) | [g] | [%] |
|---|---|---|
| Dispersion of Ag nanoplatelets (40% solids)¹⁾ | 4.59 | 4.59 |
| Laromer LR 8863²⁾ | 12.25 | 12.25 |
| Omnirad 127³⁾ | 0.69 | 0.69 |
| TEGO AddBond LP 1600⁴⁾ | 1.02 | 1.02 |
| Irgastab UV 22⁵⁾ | 0.04 | 0.04 |
| Fluorinated block copolymer solution⁶⁾ | 0.13 | 0.13 |
| Laromer DPGDA⁷⁾ | 2.72 | 2.72 |
| 1-methoxy-2-propanol⁸⁾ | 78.56 | 78.56 |
| Sum | 100 | 100 |

¹⁾Obtained in Step c) of Example 1 of WO2020/083794
²⁾Commercially available from BASF SE
³⁾Commercially available from IGM Resins
⁴⁾Commercially available from Evonik
⁵⁾Commercially available from BASF SE
⁶⁾Fluorinated block copolymer E-1 in a mixture of 1-methoxy-2-propylacetate and 1-methoxy-2-propanol, obtained in Step b) of Synthesis Example 2 of European patent application no. 21173520.4
⁷⁾Commercially available from BASF SE
⁸⁾Commercially available from Sigma-Aldrich

After mixing of the components the dispersion was stirred for 1 h under ambient conditions and then used for the slot-die coating experiments.

### Slot-Die Coating:

The coating composition (II) was applied on a Melinex 506 foil, pre-coated with Lumogen OVD 311 varnish as described above (Substrate preparation section), using a slot-die coater (TSE Troller Coating Secret). The solvent was evaporated by means of an air-dryer and the coating was cured under nitrogen atmosphere using a broad band iron-doped mercury lamp (total UV energy 3 J/cm²). The dried and UV-cured layer thickness was determined by TEM analysis of cross sections of the coatings. The results, along with coating parameters and observed color flops are provided in Table 1.

TABLE 1
Slot-die coating parameters, layer thickness
and observed color flops on the coating side.

| | | | | Dosage | TEM layer | color flop |
|---|---|---|---|---|---|---|
| Appl. | Slot width | Gap over | V Table | rate | thickness | vertical / angular |
| Example | [mm] | substr. [μm] | [m/min] | [mL/min] | [nm] | view |
| 2 | 50 | 50 | 1 | 0.09 | 230-260 | purple / orange |
| 3 | 50 | 50 | 1 | 0.11 | 280-300 | blue-green / |
| | | | | | | purple |
| 4 | 50 | 50 | 1 | 0.37 | 840-870 | apricot / green |
| 5 | 50 | 50 | 2 | 0.37 | 450-490 | green / purple |
| 6 | 50 | 50 | 2 | 0.46 | 620-690 | green / yellow |

The exemplary TEM images of cross-sections of coatings obtained in Application Examples 4 and 5 are shown in FIGS. 1 and 2. As evident from FIGS. 1 and 2 the silver particles align both, on the substrate-varnish and varnish-air interface, thus generating a Fabry-Perot stack of reflective layers, separated with a varnish layer, which is substantially free of silver particles.

1.-15. (canceled)

16. A decorative, or security element, comprising in this order
(a) a substrate;
(b) a coating, comprising transition metal particles (A) having a number mean diameter in the range of from 15 nm to 700 nm, wherein the transition metal is selected from silver, copper, gold and palladium;
(c) optionally a protective coating;
wherein the coating (b) is derived from
(b1) a solvent based composition, comprising the transition metal particles and a vehicle; and
(b2) the coating (b) has a three-layer structure:
(b2a) a layer, comprising the transition metal particles and the vehicle;
(b2b) a layer, comprising the vehicle, which is essentially free of transition metal particles; and
(b2c) a layer, comprising the transition metal particles and the vehicle; wherein the three-layer structure exhibits intensive angle-dependent colors in reflection on the coating side and/or on the substrate side of the decorative, or security element and a distinctive color in transmission.

17. A method for producing a decorative, or security element, comprising in this order
(a) a substrate;
(b) a coating, comprising transition metal particles (A) having a number mean diameter of from nm to 700 nm, wherein the transition metal is selected from silver, copper, gold and palladium;
(c) optionally a protective coating;
wherein the coating (b) is derived from
(b1) a solvent based composition, comprising the transition metal particles and a vehicle; and
(b2) the coating (b) has a three layer structure:
(b2a) a layer, comprising the transition metal particles and a vehicle;
(b2b) a layer, comprising the vehicle, which is essentially free of transition metal particles;
(b2c) a layer, comprising the transition metal particles and the vehicle; comprising the steps of
i) applying a solvent based composition comprising transition metal particles and the vehicle; on at least part of the surface of the substrate, and
ii) drying the solvent based composition;
iii) curing the solvent based composition so as to form the three-layer structure which exhibits intensive angle-dependent colors in reflection on the coating side and/or on the substrate side of the decorative, or security element and a distinctive color in transmission; and
iv) optionally applying a protective coating on the coating (b).

18. The decorative, or security element according to claim 16, wherein the three-layer structure has a thickness in the range of from 200 to 600 nm.

19. The decorative, or security element according to claim 16, wherein the transition metal particles are platelet-shaped and have a number mean diameter in the range of from 15 nm to 700 nm and the transition metal is silver.

20. The decorative, or security element according to claim 16, wherein the solvent based composition comprises
(B) one, or more reactive diluents (B);
(C) optionally one, or more oligomers (C);
(D) one, or more photoinitiators (D);
(E) optionally one, or more surfactants (E),
(F) optionally one, or more polymeric binders;
(G) one, or more solvents; and
(H) optionally further additives.

21. The decorative, or security element according to claim 20, wherein the surfactant (E) is a block copolymer, comprising at least a block A and a block B, wherein
a) the block A comprises
a1) monomer units (A1) derived from a compound selected from alkyl (meth)acrylates, alkyl (meth)acrylamides, or any mixture thereof, and
a2) monomer units (A2) derived from a hydroxy group, or ether group containing alkyl (meth)acrylate;
b) the block B comprises monomer units (B) derived from a compound selected from fluorinated (meth)acrylic esters of formula 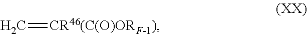
wherein
R⁴⁶ is H, or a methyl group; and
R_{F-1} is an organic residue containing a perfluorinated alkyl group.

22. The decorative, or security element according to claim 16, wherein the layer (b2b) has a varying thickness such that at least two regions of the layer (b2b) have different thicknesses, which results in at least two distinct regions having different angle-dependent colors in reflection on the coating side and/or on the substrate side of the security, or decorative element; or
wherein the layers (b2a) and (b2c) comprise each at least two different regions comprising silver particles exhibiting different angle-dependent colors in reflection on the coating side and/or on the substrate side of the security, or decorative element; or
wherein the layers (b2a) and (b2c) comprise each at least two different regions comprising different amounts of silver particles which results in at least two distinct regions having different angle-dependent colors in reflection on the coating side and/or on the substrate side of the security, or decorative element.

23. The method according to claim 22, wherein the varying thickness of the layer (b2b) is caused by embossing the substrate, or by embossing the solvent based composition after evaporation of solvent.

24. The decorative, or security element according to claim 16, wherein the layer (b2b) comprises at least in regions thereof a saw tooth structure, a triangular structure, a wave-like pattern, a step-like-structure, checker-board pattern and/or a diffractive relief structure.

25. The method according to claim 17, wherein in step i) the solvent based composition is applied onto the substrate by slot-die coating, or by ink jet printing.

26. The decorative, or security element according to claim 16, wherein the substrate (a) comprises partially de-metallized regions on top of which the three-layer structure (b2) is arranged.

27. The decorative, or security element according to claim 16 wherein the decorative, or security element, comprises a high refractive index layer between the substrate (a) and the three-layer structure (b2) and/or between the three-layer structure (b2) and the protective coating (c).

28. The method according to claim 17, which comprises i) applying a solvent based composition comprising transition metal particles and the vehicle;
on at least part of the surface of the substrate,
ii) drying the solvent based composition;
ii1) embossing a nano- or microstructure into the coating obtained in step ii) and
iii) curing the solvent based composition so as to form the three-layer structure which exhibits intensive angle-dependent colors in reflection on the coating side and/or on the substrate side of the decorative, or security element and a distinctive color in transmission; and
iv) optionally applying a protective coating on the coating (b).

29. A product, comprising the decorative, or security element according to claim 16.

30. A method for preventing the counterfeit or reproduction, on a document of value, right, identity, a security label or a branded good comprising utilizing the decorative, or security element according to claim 16.
